(19) United States
(12) Patent Application Publication
(10) Pub. No.: US 2024/0037139 A1
(43) Pub. Date: Feb. 1, 2024

(54) IDENTIFYING SIMILAR DIGITAL ASSETS FROM RESULTS OF A MULTI-USER SEARCH OF DIGITAL ASSETS, COMPARING DIGITAL ASSETS AND PROVIDING PERSISTENT SEARCH RESULTS OF THE MULTI-USER SEARCH

(71) Applicant: Haworth, Inc., Holland, MI (US)

(72) Inventors: Rupen CHANDA, Austin, TX (US); Peter JACKSON, Orinda, CA (US)

(73) Assignee: Haworth, Inc., Holland, MI (US)

(21) Appl. No.: 18/376,979

(22) Filed: Oct. 5, 2023

Related U.S. Application Data
(63) Continuation of application No. 18/217,434, filed on Jun. 30, 2023.
(60) Provisional application No. 63/357,602, filed on Jun. 30, 2022.
(60) Provisional application No. 63/413,534, filed on Oct. 5, 2022.

(51) Int. Cl. G06F 16/535; G06F 16/538

(52) U.S. Cl. CPC G06F 16/535; G06F 16/538

(57) ABSTRACT

Systems and methods are provided for searching one or more sources of digital assets in dependence on one or more keywords. The server node includes logic to identify initial results from the searching of one or more sources of digital assets. The initial search results are accessible by any client node participating in a collaboration session. The server node includes logic to receive an identification of a particular digital asset from the initial results. The server node includes logic to further search the one or more sources of digital assets in dependence on the identified particular digital asset to obtain further results. The server node includes logic to curate the further results as digital assets in a workspace that is accessible in the collaboration session. The digital assets can be curated into separate canvases within the workspace in dependence on at least one criterion.

### PRIORITY APPLICATION

This application is a continuation-in-part of U.S. Non-Provisional application Ser. No. 18/217,434 (Attorney Docket No. HAWT 1045-2), entitled “Multi-User Searching of Sources of Digital Assets and Curation of Search Results in a Collaboration Session”, filed on 30 Jun. 2023, which claims the benefit of U.S. Provisional Patent Application No. 63/357,602 (Attorney Docket No. HAWT 1045-1), entitled, “Multi-User Searching of Sources Digital Assets and Curation of Search Results in a Collaboration Session,” filed on 30 Jun. 2022; this application claims the benefit of U.S. Provisional Patent Application No. 63/413,534 (Attorney Docket No. HAWT 1046-1), entitled, “Identifying Similar Digital Assets From Search Results of a Multi-User Search of Digital Assets, Comparing Digital Assets and Providing Persistent Search Results of the Multi-User Search”, filed on 5 Oct. 2022, which applications are incorporated herein by reference.

### FIELD OF INVENTION

The present technology relates to collaboration systems that enable users to collaborate in a virtual workspace in a collaboration session. More specifically, the technology relates to efficiently searching sources of digital assets, curating search results, comparing search results and sharing search results with other users in a collaboration session.

### BACKGROUND

A user can search one or more sources of digital images or digital asset management (DAM) systems using search keywords. When the user receives search results from a source of digital images (e.g., a search engine, or a proprietary digital asset management system), it is difficult to share the search results with other users. The user can either download all search results to a local storage and then send the search results via an email or some other medium to the other users. The user could also upload the search results to a cloud-based storage and send a link to the storage location to other users so that they can view the search results. This method is very time consuming and may not be very useful, especially when there are a large number of digital images. The user who has performed the search could send a link that initiates a similar or same search to the other users. The other users can select the link to rerun the similar or same search. However, the other users may get different search results due to various reasons. For example, different geographical locations of users can cause differences in search results as some digital images may not be available in certain geographical location of the world. Further, when different users use the same link to rerun a search at different times, they can receive different search results as some digital images may not be available or accessible to the search engine at a later time or there may be new digital images that are available, such that different results are provided to the users based on when the search is performed. In some cases, accessing the link can provide the digital images to different users in different order or in a different arrangement. When searching for digital assets, a user may want to search sources of digital assets for digital assets similar to one or more search results. In this case, the user needs to save the search results to a local storage and then upload the stored search results to a search engine for further searching. This process can be time consuming, especially when users in a multi-user search and review session need to search similar digital assets corresponding to multiple search results. All these issues can reduce the effectiveness of search, review and selection of digital images.

An opportunity arises to provide a technique for efficient searching, reviewing and sharing of digital assets in a collaboration session between multiple users.

### SUMMARY

A system and method for operation a server node are disclosed. The method includes searching, by the server node, one or more sources of digital assets in dependence on one or more keywords received from a first client node participating in a collaboration session. The method includes, identifying initial results from the searching of the one or more sources of digital assets, the initial results are accessible by any client node participating in the collaboration session. The method includes, receiving, at the server node and from at least one client node, an identification of a particular digital asset from the initial results. The method includes, further searching, by the server node, the one or more sources of digital assets in dependence on the identified particular digital asset to obtain further results. The method includes, curating, by the server node, the further results as digital assets in a workspace that is accessible in the collaboration session. The digital assets can be curated into separate canvases within the workspace in dependence on at least one criterion.

The identification of the particular digital asset can include at least one keyword.

The one or more sources of digital assets include one or more publicly available sources of images. Examples of publicly available sources of images include Getty Images, Shutterstock, iStock, Giphy, Instagram, Twitter, etc.

The identification of the particular digital asset can include data that includes at least a portion of the digital asset. For example, a portion of an image, a clip from a video, or a segment or portion of audio recording, a slide from a slide deck, a page from a document, a portion of a three-dimensional (3D) model, etc.

The particular digital asset can be at least one of an image, a video clip, an audio clip and a three-dimensional model.

In one implementation, the method includes, inputting at least a portion of the particular digital asset to a trained machine learning model. The method includes, receiving at least one classification for the particular digital asset from the trained machine learning model. The further searching can include searching, by the server node, the one or more sources of digital assets in dependence on the classification of the particular digital asset.

In one implementation, the method includes, receiving, at the server node and from at least one client node, an identification of at least two digital assets selected for comparison from the initial results. The method includes, curating, by the server node, the at least two digital assets selected for comparison in a workspace. The at least two digital assets selected for comparison placed side-by-side in a same canvas.

The initial results are accessible to the client nodes participating in the collaboration session as a result of the server node providing, to the client nodes, a spatial event map identifying a log of events in the workspace. Entries within the log of events can include respective locations of digital assets related to (i) events in the workspace and (ii) times of the events. A particular event identified by the spatial event map can be related to the curating of the further results.

The one or more sources of digital assets can include at least one private repository of digital assets that is only accessible to authorized users.

The further searching includes searching, by the server node, the at least one private repository of digital assets. The client nodes include an authorized client node operated by an authorized user to access the at least one private repository of digital assets. The curated further results can include at least one private digital asset from the least one private repository of digital assets.

The method further includes receiving, at the server node, an event from the authorized client node identifying that the authorized user has left the collaboration session. The method includes, sending, from the server node, an update event to client nodes that allows display of an updated workspace at respective client nodes. For a client node that is not an authorized client node, the updated workspace prevents display of the at least one private digital asset from the least one private repository of digital assets.

The method further includes, receiving, at the server node, from at least one client node, identification of at least two digital assets from the initial results. The method includes, generating common features of the at least two digital assets by providing at least a portion of each of the at least two digital assets to a trained machine learning mode. The method includes, further searching, by the server node, the one or more sources of digital assets in dependence on the generated common features of the at least two digital assets.

The method further includes, receiving, at the server node, from at least one client node, identification of at least two digital assets from the initial results. The method includes further searching, by the server node, the one or more sources of digital assets in dependence on the identified at least two digital assets form the initial results.

A system including one or more processors coupled to memory is provided. The memory is loaded with computer instructions to operate a server node. The instructions, when executed on the one or more processors, implement operations presented in the method described above.

Computer program products which can execute the methods presented above are also described herein (e.g., a non-transitory computer-readable recording medium having a program recorded thereon, wherein, when the program is executed by one or more processors the one or more processors can perform the methods and operations described above).

Other aspects and advantages of the present technology can be seen on review of the drawings, the detailed description, and the claims, which follow.

### BRIEF DESCRIPTION OF THE DRAWINGS

The technology will be described with respect to specific embodiments thereof, and reference will be made to the drawings, which are not drawn to scale, described below.

FIGS. 1 and 2 illustrate example aspects of a system implementing searching of digital assets, curation of search results and sharing of digital assets with other users.

FIGS. 3A, 3B, 3C and 3D present an example web-based collaboration system for searching digital assets from sources of digital assets.

FIGS. 4A, 4B, 4C, 4D, 4E and 4F present an example collaboration system for searching digital assets from one or more sources of digital assets.

FIGS. 5A, 5B, 5C and 5D present an example collaboration system in which digital assets received from a plurality of sources of digital assets are arranged in multiple canvases or sections on a workspace.

FIGS. 6A, 6B and 6C present an example in which additional columns or rows of digital assets can be added to a canvas displaying digital assets received from a source of digital assets in response to a search performed using one or more keywords.

FIG. 7 presents a toolbar that includes tools (or controls) to perform various operations on a digital asset.

FIGS. 8A, 8B, 8C and 8D present a feature of the technology disclosed that allows digital assets to be dragged from a canvas or a section and placed (or dropped) on another location on the workspace.

FIGS. 9A, 9B and 9C present an example in which digital assets related to various topics or keywords are searched from a source of a digital assets and placed on a canvas.

FIGS. 10A, 10B, 10C and 10D present an example in which selected digital assets are used to populate a canvas or a section on the workspace.

FIGS. 11A, 11B, 11C, 11D, 11E, 11F, 11G, 11H and 111 present an example of placing various graphical or geometrical shapes on the workspace and arranging the digital assets in those shapes.

FIGS. 12A, 12B and 12C present an example of system for searching digital assets from sources of digital assets in a collaboration session.

FIG. 13 presents a flow diagram including operations performed by a server node for searching, curating and sharing digital assets.

FIG. 14 presents a computer system that implements the searching and curation of digital assets in a collaboration environment.

FIGS. 15A and 15B present an example of selecting digital assets in a workspace and further searching sources of digital assets for digital assets that are similar to selected digital assets.

FIGS. 16A and 16B present an example of selecting digital assets in workspace and comparing the selected digital assets.

FIGS. 17A and 17B present an example of searching and displaying search results from a private repository of digital assets.

### DETAILED DESCRIPTION

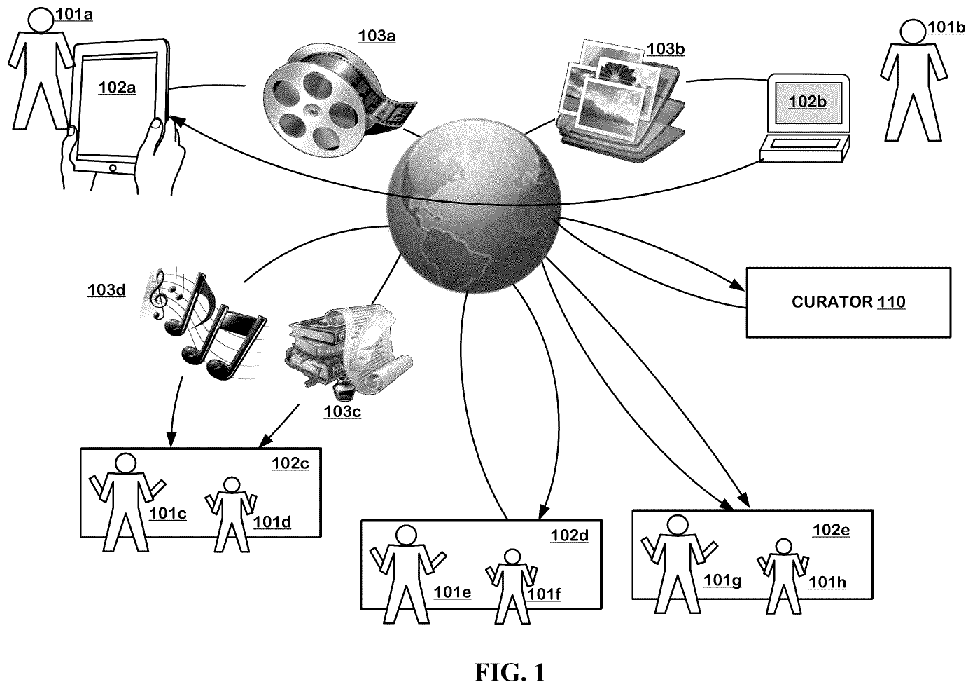

A detailed description of embodiments of the present technology is provided with reference to FIGS. 1-17B.

The following description is presented to enable a person skilled in the art to make and use the technology and is provided in the context of a particular application and its requirements. Various modifications to the disclosed embodiments will be readily apparent to those skilled in the art, and the general principles defined herein may be applied to other embodiments and applications without departing from the spirit and scope of the present technology. Thus, the present technology is not intended to be limited to the embodiments shown, but is to be accorded the widest scope consistent with the principles and features disclosed herein.

### Introduction

Collaboration systems are used in a variety of environments to allow users to contribute and participate in content generation and review. Users of collaboration systems can join collaboration sessions from remote locations around the world. A participant in a collaboration session can share digital assets or content with other participants in the collaboration session, using a digital whiteboard (also referred as a virtual workspace, a workspace, an online whiteboard, etc.). The digital assets can be documents such as word processor files, spreadsheets, slide decks, notes, program code, etc. Digital assets can also be native or non-native graphical objects such as images, videos, line drawings, annotations, 3D models, architectural drawings, etc. The digital assets can also include websites, webpages, web applications, cloud-based or other types of software applications that execute in a window or in a browser displayed on the workspace.

Users of collaboration systems can join collaboration sessions from remote locations around the globe. A user can provide search keywords to allow searching of digital assets or content from multiple sources of digital assets. The technology disclosed can use one or more key-phrases for searching digital assets. A key-phrase can comprise at least one of a text-based keyword, one or more spoken words, a portion of an image, a brief description or a sentence such as taken from a document, selected lines of code from a computer program, portions of three-dimensional models, etc. The technology disclosed can use a variety of trained machine learning models that can analyze various types of inputs (such as text, images, web-based resources including webpages, websites, etc.) and output classifications that can be used as key-phrases for searching sources of digital assets. The digital assets can be curated and shared with other users. The user can start a collaboration session with other users to review search results and perform further searching and curation of digital assets. Users can search for digital assets such as images, videos, documents, or text, using, from within or outside of the collaboration system, search engines e.g., Getty Images™, Shutterstock™™, iStock, Giphy™, Instagram™ Twitter™, Google™ or any other digital asset management system. In existing systems, the search results may not be easily shared with other users who may be working on the same project. For example, when a user wants to share images, videos, documents, etc., for collaborative work, the user will need to copy the search results into a separate document (or platform) and then share the document (or access to the platform) with other users. Specifically, the user will need to download the results of their search or copy various links to the results and then share the downloaded results of their search or the copied links to search results with other users. This process is cumbersome and does not allow for easy and quick review of search results such as images, videos, documents, etc.

The technology disclosed allows efficient search of digital assets from a plurality of sources of digital assets or digital asset management systems. Examples of sources of digital assets or digital asset management systems include Getty Images™, Shutterstock™, iStock™ Giphy™, Instagram™, Twitter™, Google™ or any other digital asset management (DAM) system. Combinations of two or more sources of digital assets or digital asset management systems can be searched as well. A participant or a user can invite additional participants or users to join and collaboratively conduct further search, review and/or curation of search results (i.e., digital assets). The technology disclosed allows registered users and anonymous users (who are not registered with the system) to participate in collaborative search and curation of digital assets. One or more participants in a collaboration session can be anonymous participants that are not registered with the system. They can join the collaboration session anonymously (such as guest users) without providing credentials (such as a username and/or password or another type of access credential) or user account information. A group of participants in a collaboration session can include some participants that are registered users of the system and some other participants that are anonymous users and are not registered with the system. The technology disclosed allows participants of a collaboration session to collaboratively search the digital assets in a collaboration session. The participants can collaborate in this search of digital assets in a synchronous (i.e., at the same time in a collaboration session) and as well as in an asynchronous manner (i.e., independently at different times). The technology disclosed allows a user to invite any number of new participants to the collaborative search session with no additional registration required. The invited participants can join the collaboration search session as anonymous participants.

The participants of the collaboration session can review the search results and select digital assets during the collaboration session based on review and discussion amongst participants. The selected digital assets can then be used for a next phase of the project or shared with other teams or users for their consumption. Thus, technology disclosed saves time and effort required by multiple users to search independently and then review search results of other users. All participants of the meeting can work together and conduct multi-user search in the same collaboration session.

One or more participants may select a digital asset in the search results and may want to search for similar digital assets. In existing system, the participant may need to download the selected search result (such as an image) and then upload the saved search results to a search engine or a digital asset management system for searching similar digital assets. This process can be very time consuming especially when the participants are reviewing a large number of search results and may want to find similar digital assets for many search results. The technology disclosed allows a participant to select a digital asset displayed on a workspace and select a user interface element to search similar digital assets. The participant can also select search engines or DAMs for searching digital assets similar to the selected search result. The technology disclosed sends the selected search result or a portion of the selected search result to search engines for searching similar digital assets. In one implementation, a trained machine learning model can classify the selected search result. The classification of the search results and/or the search result are then sent to the search engine for searching similar digital assets. The search results returned by the search engines are then organized (curated) into separate canvases. Each canvas presenting search results from a separate search engine and/or a digital asset management system. The search results can also be organized in separate canvases per user or per participant who invoked the “find similar” feature.

In some cases, it is useful to compare two or more search results side-by-side for selection of a suitable digital asset for further processing in a collaboration session. Comparing search results in existing systems is cumbersome, as a user needs to download the search results and save them to a storage location. Then the saved digital assets can be opened using an appropriate application to display them side-by-side for comparison. The technology disclosed provides an efficient solution for comparing search results. A user can simply select search results on the workspace and select a user interface element to compare the selected digital assets. The technology disclosed includes to logic to display the selected digital assets in a separate canvas for comparison. The participants of the collaboration session can select two or more digital assets from a same or separate canvases (or from separate workspaces) for comparing the selected digital assets. The technology disclosed thus provides a one step process for comparing search results that does not require downloading of search results.

The technology disclosed can be used to generate persistent search results over serval time intervals. Existing search and metasearch technologies do not provide persistent search results. For example, when digital assets are searched using existing search engines the search results can be shared by a user who performed the search with other users by either sharing a uniform resource locator (or URL) of the search results or a web page presenting the search results. However, this method of sharing search results does not guarantee that same search results will be presented to the user with whom the search results are shared when a search is performed using the URL or using the same search keywords as used by the user who performed the initial search. The technology disclosed enables persistent sharing of digital assets using a sharable container of digital assets. A user can search for digital assets from sources of digital assets and then share persistent search results with other users or participants. The search results (i.e., images, videos, text, etc.) are downloaded and temporarily stored in the sharable container of digital assets which makes the searches performed by the technology disclosed as persistent. Further details of the sharable container of digital assets are presented in the following sections.

Search results can be saved to a container (such as a spatial event map). Such container is shareable and multi-party and/or multi-user enabled. One or more users who searched for digital assets or who are participating in the collaboration session can curate the digital assets. In some cases, the curation of digital assets can be performed automatically based on pre-defined criteria. A user can then share the curated digital assets with other users by simply sharing the container. When shared with other users, all users of the collaboration session can independently search and curate digital assets in the same collaboration space. The search results received from the sources of digital assets can be ephemeral i.e., temporarily stored in the spatial event map (or the sharable container). The curated digital assets can be stored permanently while the remaining search results may be discarded. One or more users can provide further search keywords for performing a new search of the digital assets from sources of digital assets. Therefore, the search and curation process can be performed iteratively by the participants of the collaboration session. The users of the collaboration session can also search the search results using search keywords.

The technology disclosed can be used to efficiently search public and private repositories of digital assets. When at least one participant of the collaboration session is authorized to access a private repository of digital assets, the search results from the private repository can be displayed on the workspace. However, if the authorized user leaves the collaboration session, then the technology disclosed stops display of search results from private repository of digital assets on the workspace. Further details of this feature of the technology disclosed are presented in the following sections.

The technology disclosed provides two implementations to conduct the multi-user search and curation of digital assets. In a first implementation of the technology disclosed, the participants (or users) collaborate using a collaboration system. In a second implementation of the technology disclosed, the participants (or users) can collaborate using a web-based system.

### Collaboration System-Based Implementation

When using the first implementation (i.e., using the collaboration system), the users of the collaboration system can perform the following operations. Within a collaboration environment, a first user can initiate a search by entering one or more search keywords and pressing a search button. The user can also search using non-text type of inputs. For example, the user can upload an image or a video to search the sources of digital assets using the uploaded image or video in the search query. The collaboration environment presents a user interface element that allows a user to select one more sources of digital assets to search. The user provides one or more keywords to populate the search results. The server node (or collaboration server) then conducts the searching process by passing the search keywords and other search parameters to sources of digital assets such as search engines or digital asset management systems. The server node (also referred to as collaboration hosting server) can pass the search queries including search keywords and/or search key-phrases to third-party or external servers (also referred to as searching servers) that have access to sources of digital assets such as search engines and/or data asset management systems. These searching servers then pass back the search results from the sources of digital assets to the server node. The search results, as received from sources of digital assets, are populated from the multiple sources of digital assets. In some cases, only selected search results are displayed for viewing by the users. The search results can be automatically curated to different canvases, based on the one or more selected sources or based on other criteria. One or more users can select a “refresh” option and in response the canvas displaying search results can display new search results received from the source of digital assets (randomized, serial, etc.). In one implementation, for refresh feature, search results can be displayed by randomly selecting one or more digital assets from search results. In another implementation, for refresh feature, the collaboration server (or server node) can select search results in a sequential or serial manner in the order in which search results are received from the source of digital assets. The users can add more rows or columns of images in canvases to display more search results. A user who has access to the collaboration environment can access the multiple canvases and the results stored in the canvases.

The collaboration system-based implementation of the technology disclosed includes find similar digital assets feature as described above. This implementation of the technology disclosed includes comparing digital assets feature as described above. The collaboration system-based implementation of the technology disclosed includes the logic to search private repositories of digital assets as described above.

### Web-Based System Implementation

In a second implementation (i.e., using web-based system) of the technology disclosed, the users of the collaboration system can perform the following operations. A user navigates to a web page (e.g., <<www.popsync.io>>) which is the landing page for searching the digital assets. The user can select multiple sources of digital assets for searching. The user can perform keyword search from one or more selected sources of digital assets. The user can enter search keywords. The user can also search the sources of digital assets using non-text type of inputs. For example, the user can upload an image or a video to search the sources of digital assets using the uploaded image or video in the search query. The system populates the user interface with digital assets retrieved from multiple sources. The system can automatically curate results from multiple sources using multiple generated canvases, where each canvas shows results from a different source. The system can generate link to a workspace storing the multiple canvases storing the results. The workspace is accessible to anyone with a link to the workspace.

The web-based implementation of the technology disclosed includes find similar digital assets feature as described above. This implementation of the technology disclosed includes comparing digital assets feature as described above. The web-based implementation of the technology disclosed includes the logic to search private repositories of digital assets as described above.

Some key elements of the collaboration system are presented below, followed by further details of the technology disclosed.

### Virtual Workspace

In order to support an unlimited amount of spatial information for a given collaboration session, the technology disclosed provides a way to organize a virtual space termed the “workspace”. The workspace can be characterized by a multi-dimensional and in some cases two-dimensional plane with essentially unlimited extent in one or more dimensions for example, in such a way that new content can be added to the space. The content can be arranged and rearranged in the space, and a user can navigate from one part of the space to another.

Digital assets (or objects), as described above in more detail, are arranged on the virtual workspace (or shared virtual workspace). Their locations in the workspace are important for performing the gestures. One or more digital displays in the collaboration session can display a portion of the workspace, where locations on the display are mapped to locations in the workspace. The digital assets can be arranged in canvases (also referred to as sections or containers). Multiple canvases can be placed on a workspace. The digital assets can be arranged in canvases based on various criteria. For example, digital assets can be arranged in separate canvases based on their respective source of digital asset or based on digital asset management system from where the digital asset has been accessed. The digital assets can be arranged in separate canvases based on users or participants. The search results of each user can be arranged in a separate canvas (or section). Other criteria can be used to arrange digital assets in separate canvases, for example type of content (such as videos, images, PDFs documents, etc.), category of content (such as cars, trucks, bikes, etc.). The categories of content can be defined in a hierarchical manner. For example, a category “animals” can have two sub-categories as “mammals”, “non-mammals”, etc. The content can be arranged by different aspects or parts of a project. For example, one group of participants in the collaboration session may be working on exterior design of a car while another group of participants in the collaboration session may be working on electrical system design of the same car. The content searched by respective groups can be organized in different canvases within the same workspace.

The technology disclosed provides a way to organize digital assets in a virtual space termed as the workspace (or virtual workspace), which can, for example, be characterized by a two-dimensional (2D) plane (along X-axis and Y-axis) with essentially unlimited extent in one or both dimensions, for example. The workspace is organized in such a way that new content such as digital assets can be added to the space, that content can be arranged and rearranged in the space, that a user can navigate from one part of the space to another, and that a user can easily find needed things in the space when it is needed. The technology disclosed can also organize content on a three-dimensional (3D) workspace (along X-axis, Y-axis, and Z-axis).

### Viewport

One or more digital displays in the collaboration session can display a portion of the workspace, where locations on the display are mapped to locations in the workspace. A mapped area, also known as a viewport within the workspace is rendered on a physical screen space. Because the entire workspace is addressable using coordinates of locations, any portion of the workspace that a user may be viewing itself has a location, width, and height in coordinate space. The concept of a portion of a workspace can be referred to as a “viewport”. The coordinates of the viewport are mapped to the coordinates of the screen space. The coordinates of the viewport can be changed which can change the objects contained within the viewport, and the change would be rendered on the screen space of the display client. Details of workspace and viewport are presented in our U.S. application Ser. No. 15/791,351 (Atty. Docket No. HAWT 1025-1), entitled, “Virtual Workspace Including Shared Viewport Markers in a Collaboration System,” filed on Oct. 23, 2017, now issued as U.S. Pat. No. 11,126,325, which is incorporated by reference and fully set forth herein. Participants in a collaboration session can use digital displays of various sizes ranging from large format displays of sizes five feet or more and small format devices that have display sizes of a few inches. One participant of a collaboration session may share content (or a viewport) from their large format display, wherein the shared content or viewport may not be adequately presented for viewing on the small format device of another user in the same collaboration session. The technology disclosed can automatically adjust the zoom sizes of the various display devices so that content is displayed at an appropriate zoom level.

### Spatial Event Map

Participants of the collaboration session can work on the workspace (or virtual workspace) that can extend in two dimensions (along x and y coordinates) or three dimensions (along x, y, z coordinates). The size of the workspace can be extended along any dimension as desired and therefore can considered as an “unlimited workspace”. The technology disclosed includes data structures and logic to track how people (or users) and devices interact with the workspace over time. The technology disclosed includes a so-called “spatial event map” (SEM) to track interaction of participants with the workspace over time. The spatial event map contains information needed to define digital assets and events in a workspace. It is useful to consider the technology from the point of view of space, events, maps of events in the space, and access to the space by multiple users, including multiple simultaneous users. The spatial event map can be considered (or represent) a sharable container of digital assets that can be shared with other users. The spatial event map includes location data of the digital assets in a two-dimensional or a three-dimensional space. The technology disclosed uses the location data and other information about the digital assets (such as the type of digital asset, shape, color, etc.) to display digital assets on the digital display linked to computing devices used by the participants of the collaboration session.

A spatial event map contains content in the workspace for a given collaboration session. The spatial event map defines arrangement of digital assets on the workspace. Their locations in the workspace are important for performing gestures. The spatial event map contains information needed to define digital assets, their locations, and events in the workspace. A spatial events map system, maps portions of workspace to a digital display e.g., a touch enabled display. Details of workspace and spatial event map are presented in our U.S. application Ser. No. 14/090,830 (Atty. Docket No. HAWT 1011-2), entitled, “Collaboration System Including a Spatial Event Map,” filed on Nov. 26, 2013, now issued as U.S. Pat. No. 10,304,037, which is incorporated by reference and fully set forth herein.

The technology disclosed can receive search results from sources of digital assets such as public or private search engines, public or private repositories of digital assets, etc. The search results can be directly placed or saved in a collaborative search space (such as the spatial event map or SEM). The search results can be arranged in canvases (or sections) that are categorized by pre-defined criteria such as sources of digital assets, categories of content, users, etc. The technology disclosed allows sharing the search results with other users by simply inviting a user to a collaboration session. The server (also referred to as the collaboration server) sends the spatial event map or at least a portion of the spatial event map to the client node (or computing device) of a new user who joins the collaboration session using the client node. In one implementation, the collaboration server (or server node) sends a portion of the spatial event map to client nodes such that the portion of the spatial event only includes data including the search results located within the respective viewports of the client nodes. The collaboration server sends updates to the spatial event map via update events as changes to viewport are detected at respective client nodes. In one implementation, the technology disclosed includes logic to send some additional data in the spatial event map located out the boundaries of the viewport to improve the quality of user experience and reduce the response time when changes to viewport are made. The search results are displayed on the display screen of the new user. The data provided by the server node to the client node comprises a spatial event map identifying a log of events in the workspace. The entries within the log of events can include respective locations of digital assets related to (i) events in the workspace and (ii) times of the events, and wherein a particular event identified by the spatial event map being is related to the curation of a digital asset of the digital assets. Events can be generated and sent from the client nodes to the server node or from the server node to the client nodes. Events can be generated when search similar functionality is selected by a user on a client node. Similarly, events can be generated when a user invokes compare digital assets functionality from a client node or when an authorized user leaves a collaboration session initiating an event to remove display of digital assets that were received from a private repository of digital assets. Therefore, the technology disclosed uses the spatial event map technology for collaborative search and curation of digital asset from one or more sources of digital assets.

### Events

Interactions with the workspace (or virtual workspace) can be handled as events. People, via tangible user interface devices, and systems can interact with the workspace. Events have data that can define or point to a target digital asset to be displayed on a physical display, and an action as creation, modification, movement within the workspace and deletion of a target digital asset, and metadata associated with them. Metadata can include information such as originator, date, time, location in the workspace, event type, security information, and other metadata.

The curating of the digital assets can include, generating, by the server node (or collaboration server), an update event related to a particular digital asset of the digital assets. The server node includes logic to send the update event to the client nodes. The spatial event map (SEM), received at respective client nodes, is updated to identify the update event and to allow display of the particular digital asset at an identified location in the workspace in respective display spaces of respective client nodes. The identified location of the particular digital asset can be received by the server node in an input event from a client node.

The technology disclosed includes logic to receive at the server node from at least one client node, data (such as events) identifying (or some identification of) at least two digital assets selected for comparison. The technology disclosed includes logic to send data to client nodes to curate the at least two digital assets selected for comparison in a workspace. In response to the curation by the server node, the at least two digital assets selected for comparison placed side-by-side in a same canvas.

The technology disclosed includes logic to receive at the server node from at least one client node, data (such as events) identifying the digital asset for searching sources of digital assets. The server node sends a query to the selected sources of digital assets including search keywords and/or portions of the digital asset such as an image. The search results returned by the sources of digital assets are then sent to the client nodes. The server node includes the logic to send an update event to the client nodes allowing the client nodes to display the search results in a canvas on the workspace. The search results can be displayed along with the digital asset that was selected by at least one client node to search for similar digital assets.

The technology disclosed includes logic to receive an event at the server node when an authorized user leaves a collaboration session. The authorized user is authorized to access a private repository of digital assets. When no other user is authorized to access the digital assets from a particular private repository and the only authorized user who is authorized to access the particular private repository of digital assets leaves a collaboration, the client node sends an update event to the server node (or collaboration server). The collaboration server then sends an update event to client nodes to update the workspace at respective client nodes. The The curating of the digital assets can also include generating by the server node an update event related to a digital asset of the digital assets when the digital asset is removed or deleted from the workspace (or the canvas or the section). Such an update event can also be generated when a user selects to refresh one or more digital assets or search results. In this case, the digital asset is removed from the workspace (or the canvas) and the updated workspace does not allow for display of the removed digital asset. The updated workspace does not allow for the display of the private digital asset(s) from the particular private repository of digital assets. A message can be displayed on the placeholders at the private digital assets, informing the users that they are not authorized to view the private digital assets. When the authorized user again joins the collaboration session, the server node can send an update event to client nodes allowing the client nodes to display the private digital assets.

The curating of the digital assets can also include generating, by the server node, a group of digital assets returned from a selected source from of the one or more sources of digital assets. In this case, the server node generates an update event related to the group of digital assets. The server node sends the update event to the client nodes. The spatial event map, received at respective client nodes, can be updated to identify the update event and to allow display of the grouped of digital assets in the workspace in respective display spaces of respective client nodes.

Tracking events in a workspace enables the system to not only present the spatial events in a workspace in its current state, but to share it with multiple users on multiple displays, to share relevant external information that may pertain to the content and the understanding of how the spatial data evolves over time. Also, the spatial event map can have a reasonable size in terms of the amount of data needed, while also defining an unbounded workspace. Further details of the technology disclosed are presented below with reference to FIGS. 1 to 17B.

### Environment

FIG. 1 illustrates example aspects of a digital display collaboration environment. In the example, a plurality of users 101a, 101b, 101c, 101d, 101e, 101f, 101g and 101h (collectively 101) may desire to collaborate with each other when searching and reviewing various types of content including digital assets including documents, images, videos and/or web applications or websites. The plurality of users may also desire to collaborate with each other in searching of digital assets from a plurality of sources of digital assets and curation of digital assets that are received from the sources of digital assets in response to search queries. The search can be performed on one or more search keywords. The search keywords can be provided by a single user or these keywords can be provided by a plurality of users participating in the collaboration session. The plurality of users may also collaborate in the creation, review, editing and/or curation of digital assets such as complex images, music, video, documents, and/or other media, all generally designated in FIG. 1 as 103a, 103b, 103c, and 103d (collectively 103). The participants or users in the illustrated example use a variety of computing devices configured as electronic network nodes, in order to collaborate with each other, for example a tablet 102a, a personal computer (PC) 102b, many large format displays 102c, 102d, 102e (collectively devices 102). The participants can also use one or more mobile computing devices and/or tablets with small format displays to collaborate. In the illustrated example, the large format display 102c, which is sometimes referred to herein as a “wall”, accommodates more than one of the users, (e.g., users 101c and 101d, users 101e and 101f, and users 101g and 101h).

In an illustrative embodiment, a display array can have a displayable area usable as a screen space totaling on the order of 6 feet in height and 30 feet in width, which is wide enough for multiple users to stand at different parts of the wall and manipulate it simultaneously. It is understood that large format displays with displayable area greater than or less than the example displayable area presented above can be used by participants of the collaboration system. The user devices, which are referred to as client nodes, have displays on which a screen space is allocated for displaying events in a workspace. The screen space for a given user may comprise the entire screen of the display, a subset of the screen, a window to be displayed on the screen and so on, such that each has a limited area or extent compared to the virtually unlimited extent of the workspace.

The collaboration system of FIG. 1 includes a curator 110 that implements logic to arrange and organize digital assets on the workspace using one or more criteria as presented above. The digital assets are received from one or more sources of digital asset by the searching the one or more sources of digital assets in dependence on keywords. Examples of such sources of digital asset include Getty Images™, Shutterstock™, iStock™, Giphy™, Instagram™ Twitter™, etc. The curator 110 includes logic to filter, organize and/or group the search results (i.e., digital assets) into separate canvases (or sections) for further review by the participants of the collaboration session. The curating of the digital assets can be performed based on one or more pre-defined criteria. An example of a criterion for curating of digital assets into separate canvases on the workspace (or virtual workspace) is the source of the digital assets. For example, the user can search multiple sources of digital assets using the same search keyword. The curator 110 arranges the search results from each source of digital assets in a separate canvas. Another criterion to curate digital assets is based on users. For example, different users in the collaboration session can search sources of digital assets using their respective search keywords. The curator 110 can arrange the search results per user in a separate canvas. For example, if there are three users in the collaboration session and they provide their own search keywords (which can be similar or same as the keywords provided by other users) to search sources of digital assets. The curator can arrange the search results for the three participants in three separate canvases (or sections). Each canvas or section displaying search results can be labeled with a name or another identifier of a user to indicate that the canvas contains search results based on search keywords provided by the user.

In one implementation, when a user searches multiple sources of digital assets, that user's canvas can have multiple sub-canvases, each displaying digital assets from respective source of digital assets. Therefore, the curator 110 can arrange digital assets in a hierarchical arrangement of canvases.

Another example of a criterion for curating of digital assets into separate canvases includes a type of content of digital assets. For example, the search results can be arranged into separate canvases based on the type of content such as PDF documents, images, videos, etc. Additional criteria can be defined by users for curation of digital assets. For example, the users can select certain digital assets and assign a higher priority to selected digital assets. The curator 110 can arrange the higher priority digital assets in a separate canvas. The users can also perform gestures such as select multiple digital assets using a pointer or by using a finger on a touch-enabled digital display. The selected digital assets can be arranged in a separate canvas. Further operations and/or workflows can be performed on the curated digital assets. For example, the curator 110 can send the high priority digital assets to participants in an email or the high priority digital assets can be sent to another workspace which is accessible to another group of users. This is helpful for large projects where multiple teams are working on a project. One team can collaboratively search and review the digital assets. The curator 110 can then send selected digital assets to another team for next steps in the project.

The curator 110 includes logic to present selected digital assets for comparison in a canvas in a side-by-side arrangement. Similarly, the curator 110 includes logic to present search results received from sources of digital assets in a separate canvas when a user invokes “find similar” feature. The search results similar to the selected digital asset are presented in a separate canvas with the digital asset selected by the user for finding similar search results.

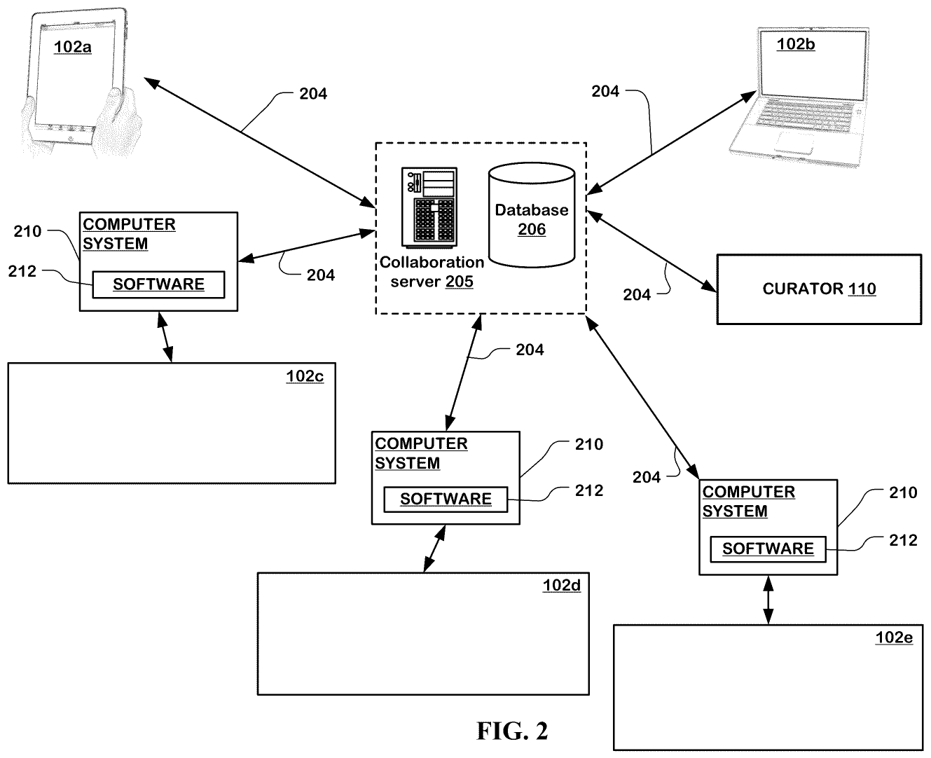

FIG. 2 shows a collaboration server 205 (also referred to as the server node or the server) and a database 206, which can include some or all of the spatial event map, an event map stack, the log of events, digital assets or identification thereof, etc., as described herein. In some cases, the collaboration server 205 and the database 206 collaboratively constitute a server node. The server node is configured with logic to receive events from client nodes and process the data received in these events. The collaboration server can pass search keywords in search queries to sources of digital assets or digital asset management systems. The collaboration server can receive search results from sources of digital assets or digital asset management systems and invoke the logic implemented in curator 110 to curate the digital assets. The curator 110 can be implemented as part of the server node or curator 110 can be implemented separately and is in communication with the server node. The server node (also referred to as collaboration server) can generate an update event related to a digital asset and/or a canvas and send the update even to the client nodes. The spatial event map, at respective client nodes is updated to identify the update event and to allow display of the digital asset at a selected location in the workspace in respective display spaces of respective client nodes. The selected location of the digital asset is received by the server node in an input event from a client node. Similarly, the curator 110 can remove the digital asset not required or not selected for placement in a canvas. The server node (or the collaboration server) can generate an update event related to the digital asset that is not needed and send the update even to the client nodes. The spatial event map, at respective client nodes is updated to identify the update event and to allow removal of the digital asset from the selected location at which the digital asset is displayed in the workspace in respective display spaces of respective client nodes. Therefore, all participants view the same curated digital assets on the respective display screens. Similarly, update events are sent from the server node (or the collaboration server) to the client nodes when digital assets are grouped together and placed in a canvas. The spatial event map at the respective client nodes is updated to identify the update event and display the selected digital assets in a group.

FIG. 2 illustrates client nodes (or client nodes) that can include computing devices such as desktop and laptop computer, hand-held devices such as tablets, mobile computers, smart phones, and large format displays that are coupled with computer system 210. Participants of the collaboration session can use a client node to participate in a collaboration session.

FIG. 2 further illustrates additional example aspects of a digital display collaboration environment. As shown in FIG. 1, the large format displays 102c, 102d, 102e sometimes referred to herein as “walls” are controlled by respective client, communication networks 204, which in turn are in network communication with a central collaboration server 205 configured as a server node or nodes, which has accessible thereto a database 206 storing spatial event map stacks for a plurality of workspaces. The database 206 can also be referred to as an event map stack or the spatial event map as described above. The curator 110 can be implemented as part of the collaboration server 205 or it can be implemented separately and can communicate with the collaboration server 205 via the communication networks 204.

As used herein, a physical network node is an active electronic device that is attached to a network, and is capable of sending, receiving, or forwarding information over a communication channel. Examples of electronic devices which can be deployed as network nodes, include all varieties of computers, workstations, laptop computers, handheld computers and smart phones. As used herein, the term “database” does not necessarily imply any unity of structure. For example, two or more separate databases, when considered together, still constitute a “database” as that term is used herein.

The application running at the collaboration server 205 can be hosted using software such as Apache or nginx, or a runtime environment such as node.js. It can be hosted for example on virtual machines running operating systems such as LINUX. The collaboration server 205 is illustrated, heuristically, in FIG. 2 as a single computer. However, the architecture of the collaboration server 205 can involve systems of many computers, each running server applications, as is typical for large-scale cloud-based services. The architecture of the collaboration server 205 can include a communication module, which can be configured for various types of communication channels, including more than one channel for each client in a collaboration session. For example, with near-real-time updates across the network, client software can communicate with the server communication module using a message-based channel, based for example on the Web Socket protocol. For file uploads as well as receiving initial large volume workspace data, the client software 212 (as shown in FIG. 2) can communicate with the collaboration server 205 via HTTPS. The collaboration server 205 can run a front-end program written for example in JavaScript served by Ruby-on-Rails, support authentication/authorization based for example on OAuth, and support coordination among multiple distributed clients. The collaboration server 205 can use various protocols to communicate with client nodes and curator 110. Some examples of such protocols include REST-based protocols, low latency web circuit connection protocol and web integration protocol. Details of these protocols and their specific use in the co-browsing technology is presented below. The collaboration server 205 is configured with logic to record user actions in workspace data, and relay user actions to other client nodes as applicable. The collaboration server 205 can run on the node.JS platform for example, or on other server technologies designed to handle high-load socket applications.

The database 206 stores, for example, a digital representation of workspace data sets for a spatial event map of each session where the workspace data set can include or identify events related to objects displayable on a display canvas, which is a portion of a virtual workspace. The database 206 can store digital assets and information associated therewith, as well as store the raw data, intermediate data and graphical data at different fidelity levels, as described above. A workspace data set can be implemented in the form of a spatial event stack, managed so that at least persistent spatial events (called historic events) are added to the stack (push) and removed from the stack (pop) in a first-in-last-out pattern during an undo operation. There can be workspace data sets for many different workspaces. A data set for a given workspace can be configured in a database or as a machine-readable document linked to the workspace. The workspace can have unlimited or virtually unlimited dimensions. The workspace data includes event data structures identifying digital assets displayable by a display client in the display area on a display wall and associates a time and a location in the workspace with the digital assets identified by the event data structures. Each device 102 displays only a portion of the overall workspace. A display wall has a display area for displaying objects, the display area being mapped to a corresponding area in the workspace that corresponds to a viewport in the workspace centered on, or otherwise located with, a user location in the workspace. The mapping of the display area to a corresponding viewport in the workspace is usable by the display client to identify digital assets in the workspace data within the display area to be rendered on the display, and to identify digital assets to which to link user touch inputs at positions in the display area on the display.

The collaboration server 205 and database 206 can constitute a server node, including memory storing a log of events relating to digital assets having locations in a workspace, entries in the log including a location in the workspace of the digital asset of the event, a time of the event, a target identifier of the digital asset of the event, as well as any additional information related to digital assets, as described herein. The collaboration server 205 can include logic to establish links to a plurality of active client nodes (e.g., devices 102), to receive messages identifying events relating to modification and creation of digital assets having locations in the workspace, to add events to the log in response to said messages, and to distribute messages relating to events identified in messages received from a particular client node to other active client nodes.

The collaboration server 205 includes logic that implements an application program interface, including a specified set of procedures and parameters, by which to send messages carrying portions of the log to client nodes, and to receive messages from client nodes carrying data identifying events relating to digital assets which have locations in the workspace. Also, the logic in the collaboration server 205 can include an application interface including a process to distribute events received from one client node to other client nodes.

The events compliant with the API can include a first class of event (history event) to be stored in the log and distributed to other client nodes, and a second class of event (ephemeral event) to be distributed to other client nodes but not stored in the log.

The collaboration server 205 can store workspace data sets for a plurality of workspaces and provide the workspace data to the display clients participating in the session. The workspace data is then used by the computer systems 210 with appropriate (client) software 212 including display client software, to determine images to display on the display, and to assign digital assets for interaction to locations on the display surface. The server 205 can store and maintain a multitude of workspaces, for different collaboration sessions. Each workspace can be associated with an organization or a group of users and configured for access only by authorized users in the group.

In some alternatives, the collaboration server 205 can keep track of a “viewport” for each device 102, indicating the portion of the display canvas (or canvas) viewable on that device, and can provide to each device 102 data needed to render the viewport. The display canvas is a portion of the virtual workspace. Application software running on the client device responsible for rendering drawing objects, handling user inputs, and communicating with the server can be based on HTMLS or other markup-based procedures and run in a browser environment. This allows for easy support of many different client operating system environments.

The user interface data stored in database 206 includes various types of digital assets including graphical constructs (drawings, annotations, graphical shapes, etc.), image bitmaps, video objects, multi-page documents, scalable vector graphics, and the like. The devices 102 are each in communication with the collaboration server 205 via a communication network 204. The communication network 204 can include all forms of networking components, such as LANs, WANs, routers, switches, Wi-Fi components, cellular components, wired and optical components, and the internet. In one scenario two or more of the users 101 are located in the same room, and their devices 102 communicate via Wi-Fi with the collaboration server 205.

In another scenario two or more of the users 101 are separated from each other by thousands of miles and their devices 102 communicate with the collaboration server 205 via the internet. The walls 102c, 102d, 102e can be multi-touch devices which not only display images, but also can sense user gestures provided by touching the display surfaces with either a stylus or a part of the body such as one or more fingers. In some embodiments, a wall (e.g., 102c) can distinguish between a touch by one or more fingers (or an entire hand, for example), and a touch by the stylus. In one embodiment, the wall senses touch by emitting infrared light and detecting light received; light reflected from a user's finger has a characteristic which the wall distinguishes from ambient received light. The stylus emits its own infrared light in a manner that the wall can distinguish from both ambient light and light reflected from a user's finger. The wall 102c may, for example, be an array of Model No. MT553UTBL MultiTaction Cells, manufactured by MultiTouch Ltd, Helsinki, Finland, tiled both vertically and horizontally. In order to provide a variety of expressive means, the wall 102c is operated in such a way that it maintains a “state.” That is, it may react to a given input differently depending on (among other things) the sequence of inputs. For example, using a toolbar, a user can select any of a number of available brush styles and colors. Once selected, the wall is in a state in which subsequent strokes by the stylus will draw a line using the selected brush style and color.

### Searching and Curation of Digital Assets in a Collaboration Session

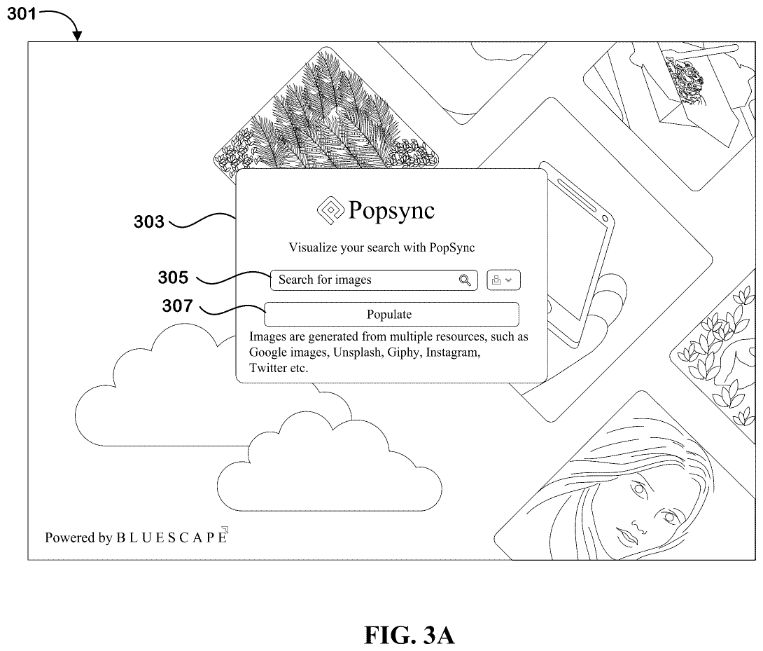

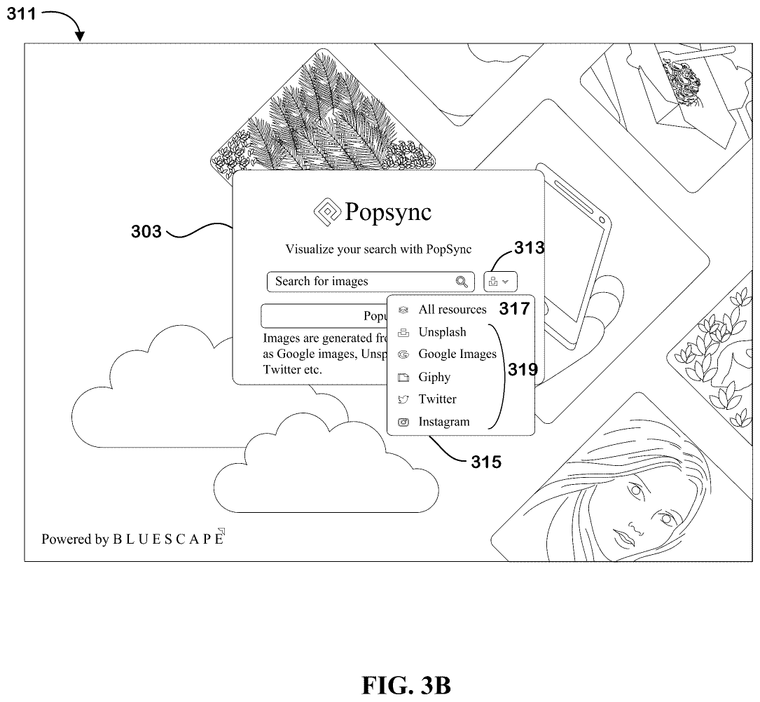

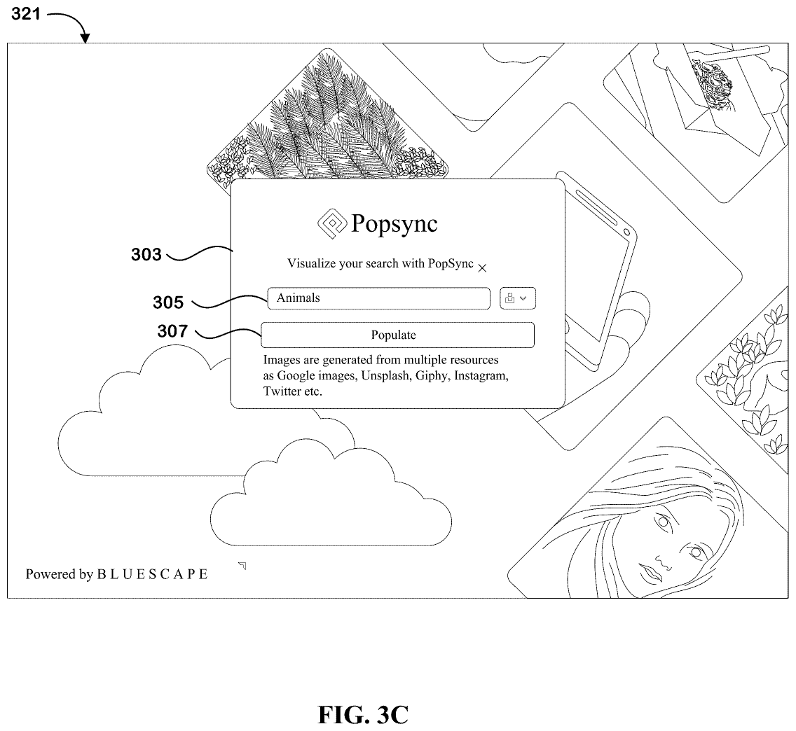

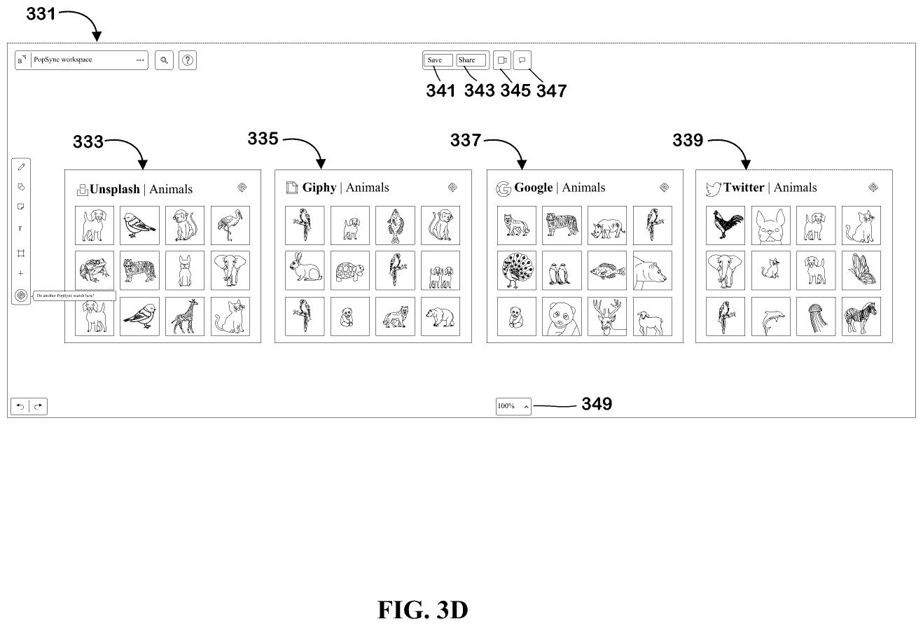

FIGS. 3A to 12C present various features and/or implementations of a collaboration system that includes logic to search digital assets from sources of digital assets or digital asset management (DAM) systems and curate search results. The following sections present further details of the technology disclosed.

FIGS. 3A to 3D present an example of a web-based collaboration system for searching digital assets and curating the search results.

FIG. 3A presents a user interface 301 that includes a user interface element (or a search dialog box) 303 that can be used to search sources of digital assets. The search keywords can be entered in a user interface element (or text input box) 305 on the search dialog box 303. A user interface element 307 can be selected to search one or more sources of digital assets or digital asset management systems.

FIG. 3B presents a user interface 311 that shows the search dialog box 303 with a drop down menu (or drop down list) 315 including a list of sources of digital assets. A user can select a user interface element 313 causing the drop down menu 315 to display. The user can select an option 317 to search all sources of digital assets or select one or more sources of digital assets in a list 319. The example sources of digital assets as listed in the list 319 can include, but are not limited to, “Unsplash™”, “Google Images™”, “Giphy™”, “Twitter™”, “Instagram™”, etc. It is understood that additional sources of digital assets can be included in the list 319. Additionally, the list 319 can also include digital asset management (DAM) systems that may access proprietary data available to users that are employees of an organization or have subscription to such DAM systems.

FIG. 3C presents a user interface 321 that shows the dialog box 303 in which a search keyword has been entered. The search keyword “Animals” is entered in the text input box 305. The user can now select the user interface element 307 to search the selected sources of digital assets using the keyword entered in the text input box 305.

FIG. 3D presents a user interface 331 that includes results of the searching of the sources of digital assets using a search keyword. The results from four sources of digital assets are presented in respective canvases (or sections) 333, 335, 337 and 339. The canvases can display search results (i.e., digital assets) in rows and columns. It is understood that that other arrangements of digital assets can be used for display such as nested circles, honeycomb pattern, etc. Customized templates can be defined for presenting search results in canvases. A canvas can include a label indicating the name (or another identifier) of the source of digital asset from where the search results are received. The user interface 331 includes a user interface element 341 which can be selected by a user to save the search results to a storage device. Such storage device can be linked to and accessible by the server node. The search results can also be stored on an enterprise data storage or a cloud-based storage. A user interface element 343 can be selected to share the search results with a user who is not participating in the collaboration session. The server node or the collaboration server uses the spatial event map to share the search results with the user. The spatial event map or a part of the spatial event map is shared with the user to enable the client node associated with the user to access the search results and display the search results on a display linked to the client node. The technology disclosed therefore, makes sharing of the search results very easy as no additional steps (such as downloading the search results and then sharing the search results with other users) are required when sharing search results with other users. The technology disclosed also allows all participants or users to view the same search results and thus facilitates collaborative review and evaluation of digital assets. A user interface element 345 can be selected to start a video collaboration session amongst participants of the collaboration session. A user interface element 347 can be selected to start a chat session amongst participants of the collaboration session. A user interface element 349 can be selected to increase or decrease a zoom level of the viewport to the workspace.

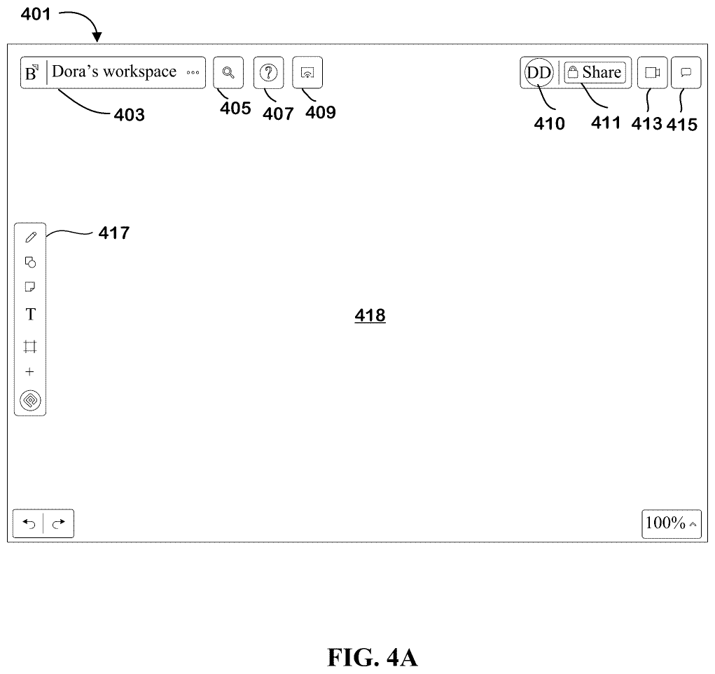

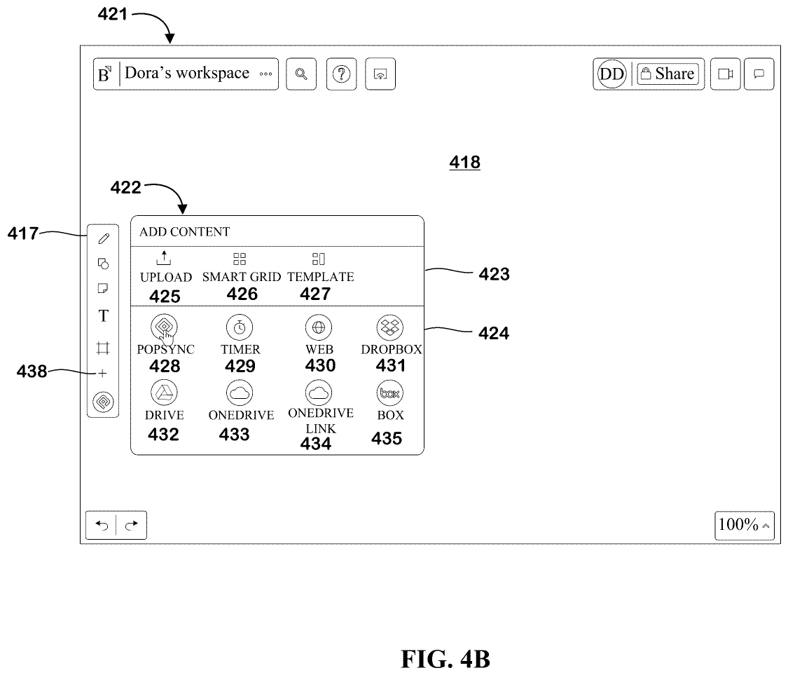

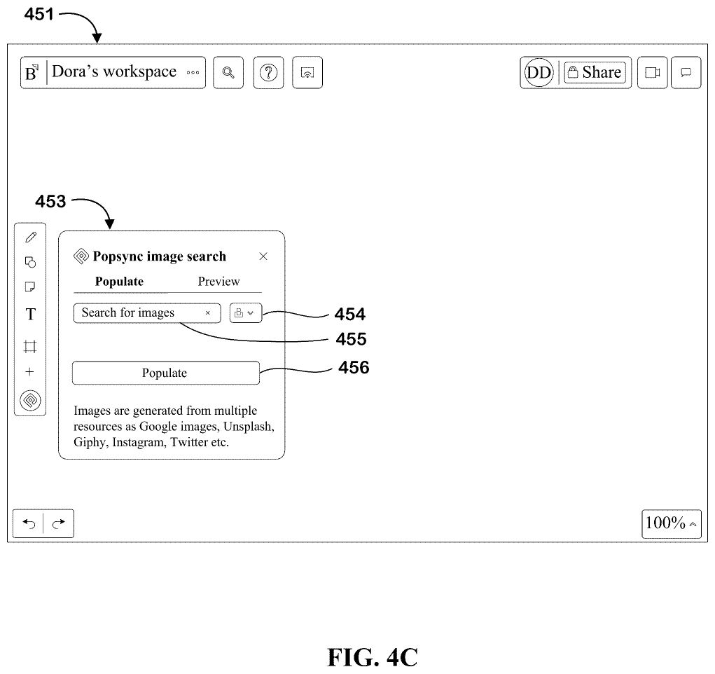

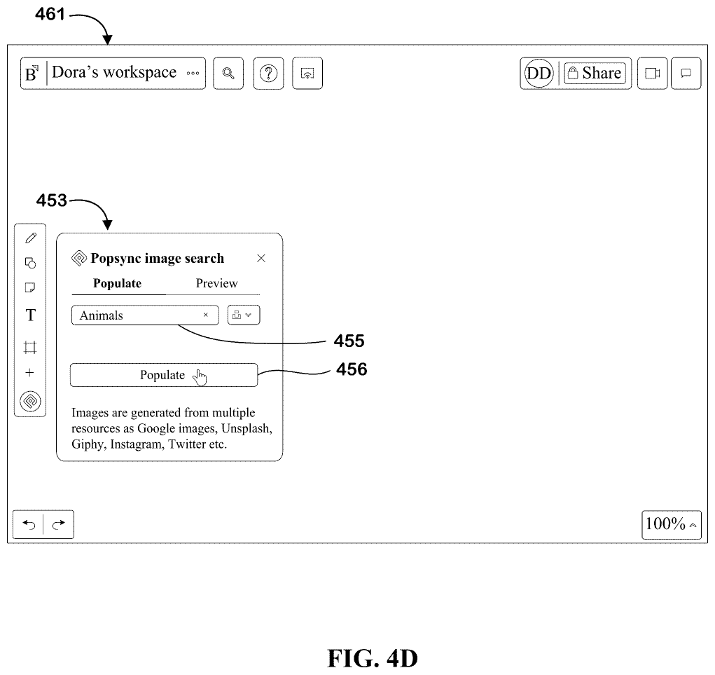

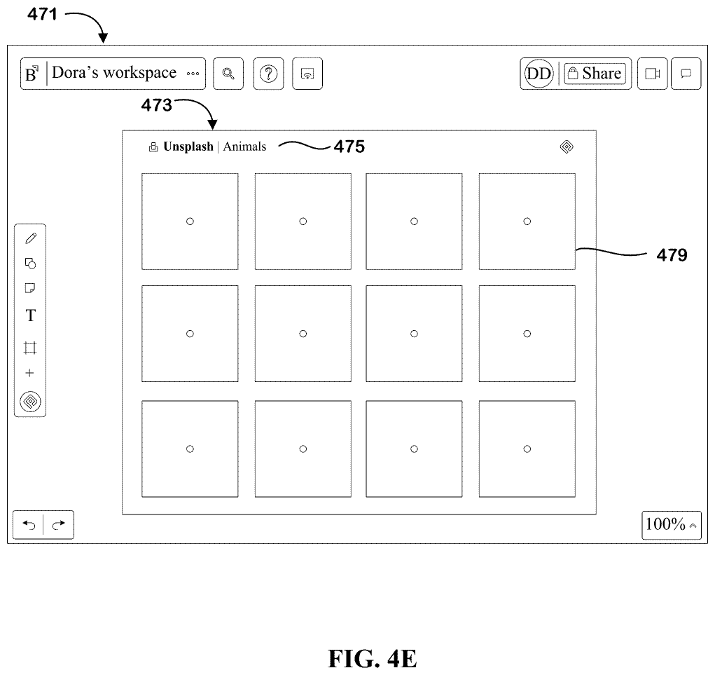

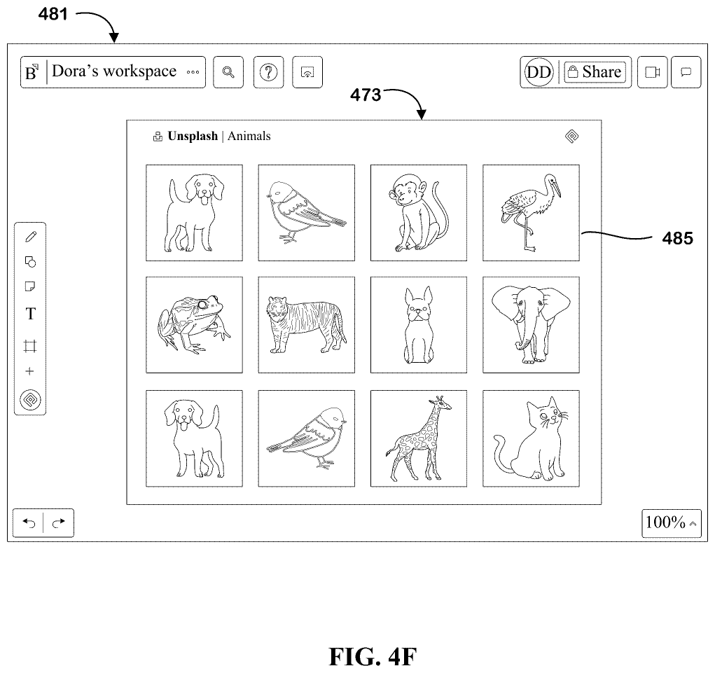

FIGS. 4A to 4F present another implementation of the technology disclosed in which a client-side application is deployed to a client node. The client node can then invoke (or launch) the client-side application to search for digital assets from sources of digital assets.

FIG. 4A presents a user interface 401 that includes a workspace 418. The user interface 401 includes a label 403 including a name, title, or another type of identifier of the workspace. The user interface 401 includes a user interface element 405 to search the workspace. The user interface 401 includes a user interface element 407 to help users find answers to their questions or queries regarding the collaboration systems. For example, selecting the user interface element can open a FAQ (frequently asked questions) dialog box or an FAQ page that can include frequently asked questions and their answers. A user interface element 409 can be used to connect the client node to a wireless internet connection such as a Wi-Fi. The user interface 401 includes a user interface element 410 that displays the names, identifiers, initials or avatars of other users participating in the collaboration session. For example, in this example, only one other user is participating in the collaboration session, thus only one label “DD” is displayed. If more users joint the collaboration session, then more labels will be displayed indicating their respective initials, names, identifiers or avatars, etc. A user interface element 411 can be selected to share the workspace with other users. A user interface element 413 can be selected to start a video collaboration session. A user interface element 415 can be selected to initiate a chat session with one or more participants of the collaboration session. A toolbar 417 includes various tools that can be used by the participants of the collaboration session. Further details of the tools (or controls or user interface elements) in the toolbar 417 are presented in the following sections.

FIG. 4B presents a user interface 421 displaying a user interface element 422 that provides tools (or controls) to add various types of digital assets to the workspace and perform various other operations related to conducting of the collaborative search session. The user interface element 422 is displayed on the display screen when a user selects a button (or a tool) 438 on the toolbar 417. The user interface element 422 comprises two sections 423 and 424. The section 423 includes a user interface element (or a button or a control) 425 that can be selected to upload a digital asset to the workspace 418. The user can select a digital asset stored in a local storage drive or in a cloud-based storage to upload to the workspace. A user interface element 426 can be selected to arrange the digital assets in a grid format (such as matrix comprising rows and columns). A user interface element 427 can be used to select a template for arranging the display of search results or digital assets on the workspace. The template can include a pattern or a format that can describe the arrangement of digital assets in a particular manner. When a particular template is selected, the technology disclosed arranges the digital assets on the workspace using the pattern or the arrangement described in the template. The section 424 of the user interface element 422 provides user interface elements (or buttons or controls) to perform various operations in a collaborative search session. For example, a user interface element 428 can be selected to start searching the sources of digital assets or digital asset management (DAM) systems. A user interface element 429 can be selected to add a timer to the workspace. A user interface element 430 can be selected to launch a browser in the workspace to access various resources on the world wide web (WWW). A user interface element 431 can be selected to access a first type of cloud-based storage (e.g., Dropbox™ cloud-based storage). A user interface element 432 can be selected to access a second type of cloud-based storage (e.g., Google Drive™ cloud-based storage). A user interface element 433 can be selected to access a third type of cloud-based storage (e.g., OneDrive™ cloud-based storage). A user interface 434 can be selected to generate a link (such as a URL or a uniform resource locator) to access a digital asset stored in the third type of cloud-based storage (e.g., OneDrive™ cloud-based storage). A user interface element 435 can be selected to access a fourth type of cloud-based storage (e.g., Box™ cloud-based storage).

FIG. 4C presents a user interface 451 that includes a user interface element (or a search dialog box) 453. The search dialog box 453 is displayed in response to selection of the user interface element 428 in FIG. 4B. A user can enter search keywords in a user interface element (or an input box) 455. One or more sources of digital assets for searching the digital assets can be selected using the user interface element 454. A user interface element 456 can be selected to initiate searching of the selected sources of digital assets in dependence on the search keywords.

FIG. 4D presents a user interface element 461 illustrating the search keyword “animals” being entered into the input box 455 in the search dialog box 453. The user selects the user interface element 456 to search the sources of digital assets in dependence on the search keyword.

FIG. 4E presents a user interface 471 including a canvas 473 in which the search results can be presented (or displayed). The canvas 473 comprises placeholders arranged in rows and columns. One such placeholder 479 is positioned on the top right corner of the canvas. The placeholders indicate the location at which search results (or digital assets) received from sources of digital assets or digital asset management systems will be displayed. A name, or a title, or a label, or an identifier, etc. of the source of digital assets and the search keywords used for searching the source of digital assets are displayed on the top of the canvas (475).

FIG. 4F presents a user interface 481 that includes the canvas 473 which is now populated with search results received from a source of digital assets. The placeholders in the canvas as shown in FIG. 4E are now replaced with digital assets received from the source of digital assets. The search results are arranged in the canvas 473 in a matrix format, i.e., in rows and columns. For example, a digital asset 485 is placed at a location at the intersection of the first row and the fourth column of the matrix. Search results can be context specific based on other information that is available based on the contents related to or associated with the workspace. For example, if content is available indicating that the workspace is related to mammals, then the keyword search for “animals” would rank and/or obtain digital assets related to not just animals, but rather mammals.

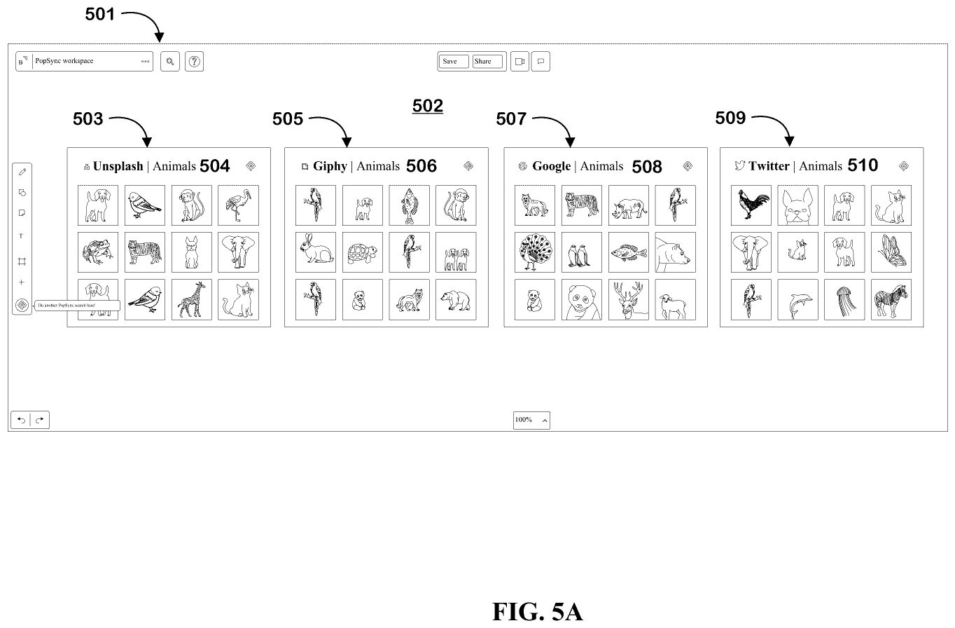

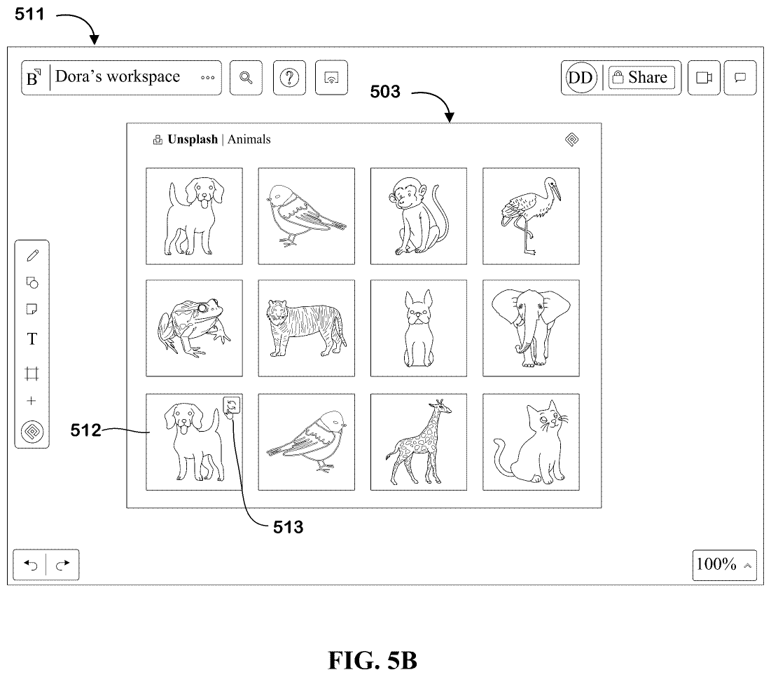

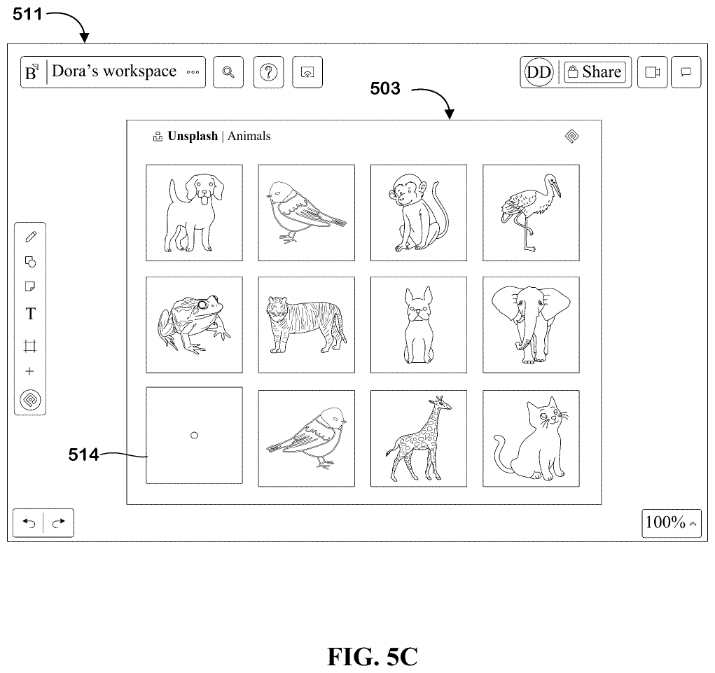

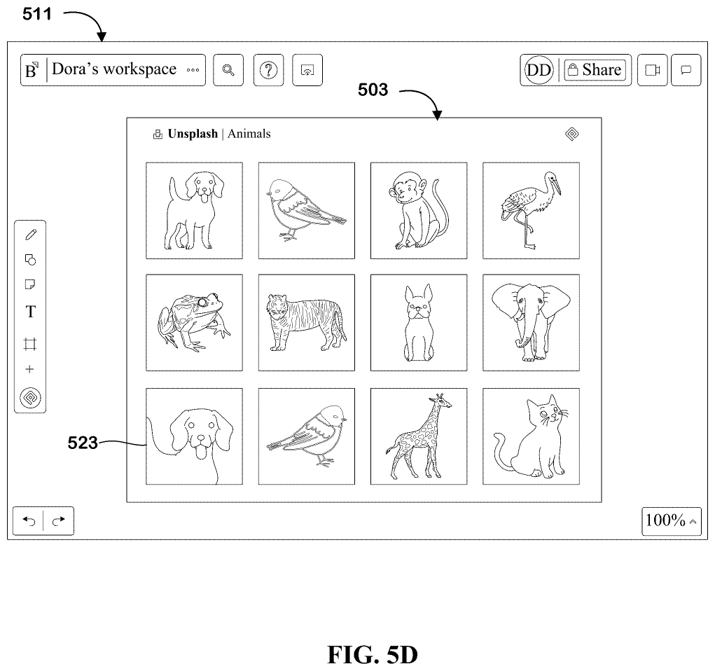

FIGS. 5A to 5D present an example in which search results are presented in multiple canvases or sections on the workspace (or the virtual workspace).

FIG. 5A illustrates a user interface 501 that presents search results displayed on a workspace 502. The search results are arranged in four canvases (or sections) 503, 505, 507 and 509. Labels 504, 506, 508 and 510 on respective canvases display respective names (or identifiers) of the sources of digital assets from which the search results are received. The labels on the canvas also display one or more search keywords that were used for searching the sources of digital assets. The technology disclosed can perform the curating of the digital assets in dependence on various criteria. For example, the technology disclosed can group the search results in separate canvases (or sections) based on the users who are participating in the collaboration session and providing search keywords to search the sources of digital assets. Suppose there are three users who are participating in the collaboration session and each user is providing their search keywords for searching the sources of digital assets. The curator 110 arranges the search results in three separate canvases. A separate canvas contains search results (or at least a part of the search results) received from one or more sources of digital assets in dependence on search keywords from each user. The canvases can be labeled with names (or other identifiers) of respective users and their respective search keywords. The canvases can be hierarchically arranged with sub-canvases (or sub-sections) per source of digital assets. For example, if one user selected two sources of digital assets for search, the canvas containing search results for that user can have two canvases (or sub-canvases) each containing search results from respective source of digital assets. Another example of a criterion that can be used for curating of the digital assets is a type of the content of search results. For example, the curator 110 can group the search results (or the digital assets) based on a type of the search results such as images (or still images), videos, PDF files, slide decks, text files, etc. Search results of the same type are placed in a same canvas (or section). For example, images can be placed in one canvas, videos can be placed in another canvas and so on. Canvases can be labeled indicating the type of content placed in respective canvases. The canvases can be arranged in hierarchical manner with sub-canvases for search results from separate sources of digital assets.

Another example of a criterion that can be applied for curating of the digital assets is image format and video format. Examples of image formats can include JPEG (joint photographic expert group), PNG (portable network graphics), GIF (graphics interchange format), SVG (scalable vector graphics), etc. Images received from sources of digital assets can be curated in separate canvases based on their respective image format. Examples of video formats include MP4, MOV, AVI, WMV, etc. Videos received from sources of digital assets can be curated in separate canvases based on their respective video formats.

The curating of the search results can also be performed based on quality of the content of search results. For example, high-resolution images and low-resolution images can be grouped in separate canvases. The canvases can be labeled accordingly. The curating of the digital assets can be performed based on the accuracy (or relevance) of the search results in relation to the search keywords. Search results with high accuracy or high relevance can be placed in one canvas while search results with low accuracy or low relevance can be placed in another canvas. The level of accuracy or relevance (i.e., high or low) can be indicated by a search engine or a source of digital assets per search result. The curator 110 can use this data for curating of the digital assets. The accuracy of the search results can also be defined based on other content in the workspace. For example, the search results that are similar to digital assets in the workspace can be classified as having high relevance while search results that are not similar to digital assets in the workspace can be classified as having low relevance. A trained machine learning model can be used by the curator 110 to classify search results and place them in separate canvases based on their respective level of relevance with respect to digital assets that are previously present in the workspace. Additional criteria for curating of the digital assets can be defined by users of the collaboration session based on specific needs of their project. The curating of the search results can help users in review and selection of digital assets and to efficiently select digital assets that meet the needs of their respective projects.

FIG. 5B presents a user interface 511 displaying search results in the canvas 503 from FIG. 5A. A search result (or digital asset) 512 is selected for replacement as shown by a refresh button 513 on the top right corner of the digital asset 512. Selecting the refresh button 513 can remove the current digital asset on which the refresh function is applied. The removed digital asset is replaced with another search result from the same (or different) source of digital assets.

FIG. 5C presents the user interface 511 displaying search results in the canvas 503. A location 514 displays a box (or a placeholder) in the canvas 503 from where the digital asset 512 of FIG. 5B is removed in response to selection of the refresh button 513. When the refresh button 513 is selected to invoke the refresh functionality, the existing digital asset 512 from that location in the canvas is removed at location 514. The collaboration server (or server node) can receive one or more additional search results from the source of digital assets to replace the removed digital asset. In one implementation, the server node can replace the removed digital asset from one of the digital assets previously received from the source of digital assets but that is not displayed on the canvas 503. The server node can temporarily store more search using the spatial event map and use one or more such results to replace the digital assets that are removed from the canvas. The temporarily stored search results can be discarded at the end of the collaboration session.

FIG. 5D presents a user interface 511 displaying search results in the canvas 503. A new digital asset 523 has now replaced the digital asset 512 (in FIG. 5B). Additional digital assets, such as those not being provided as a result of the keyword search, can also be added to the canvas 503 by a user. The additional digital assets can be any assets that are available to the collaboration system. This applies to any canvas described herein. When a search result is selected for replacement (by invoking refresh button), the collaboration server (or server node) can initiate a new search using the same search keywords as used for searching the existing search results. The collaboration server includes the logic to use a new digital asset or a new search result which is not already displayed in existing search results when replacing a digital asset in response to selection of refresh button.

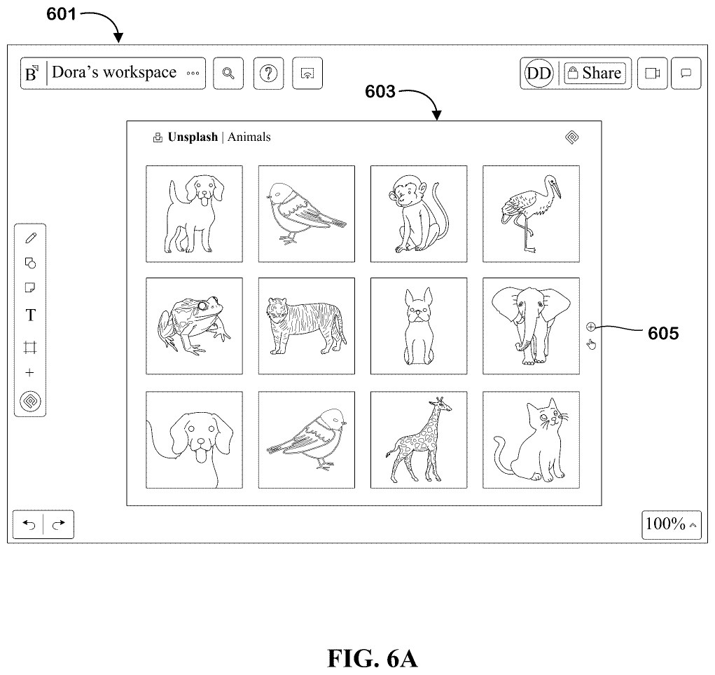

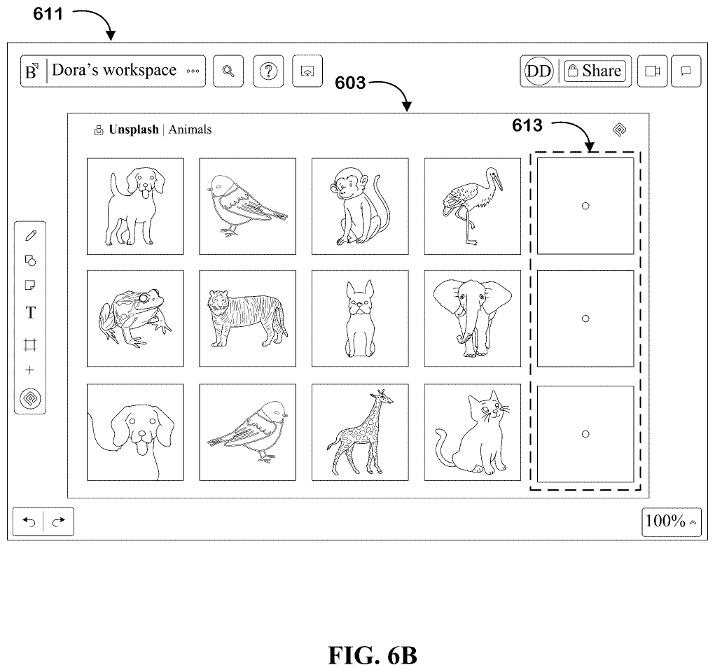

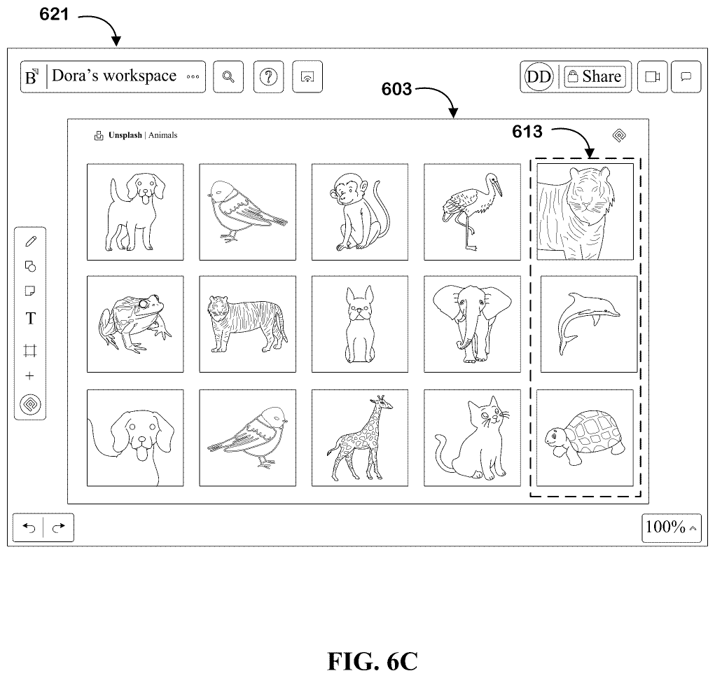

FIGS. 6A to 6C present an example in which a new column of search results is added to a canvas presenting search results in a matrix format consisting of rows and columns.

FIG. 6A presents a user interface 601 including a canvas (or a section) 603 displaying search results. A user interface element 605 is selected by a user to increase the size of the canvas (or the section) so that more search results can be displayed in the canvas.

FIG. 6B presents a user interface 611 including the canvas 603 displaying search results. The canvas 603 is now increased in size in response to selection of the user interface element 605 as shown in FIG. 6A. The canvas 603 now includes a new column 613 including placeholders or locations for displaying search results (or digital assets).

FIG. 6C presents a user interface 621 including the canvas 603. The canvas 603 now includes the new column 613 of digital assets. The collaboration server can receive new search results to fill in the new column from the source of digital assets. New rows of search results can also be added in a canvas presenting the search results.

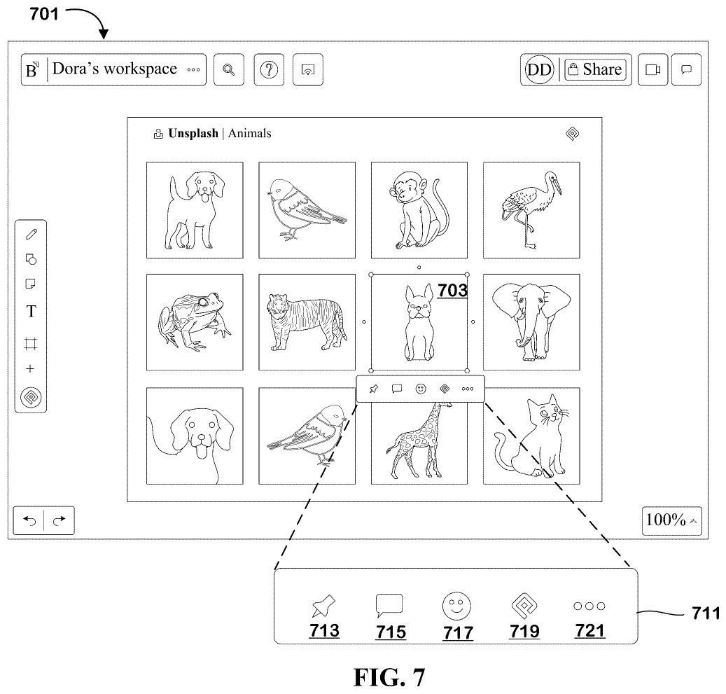

FIG. 7 presents a user interface 701 including an image control toolbar that can be used to perform various types of operations related to a search result (or a digital asset). Selection of a digital asset 703 can bring up (or display) an image control toolbar (or simply referred to as a toolbar) 711 below the selected digital asset. A magnified view of the toolbar 711 is also shown in FIG. 7. The toolbar 711 can include controls or tools to perform various operations on the selected digital asset. For example, a control 713 can be selected to pin the digital asset on a particular location in the canvas or a particular location on a workspace. The user can select a location on which to pin the digital asset or the user can pin the digital asset on a current location of the digital asset. A control 715 can be selected to write a comment on the digital asset. The comment can be viewed by other users and they can also respond to the comment. A control 717 can be selected to add an emoji on a digital asset indicating whether the user likes the digital asset or does not like the digital asset, etc. A control 719 can be selected by the user to initiate a new search using the selected digital asset in the search query. The three small circles (721) can be selected by the user to bring up more controls or tools. These tools can be used to for example, start a chat with other users regarding the selected digital asset, perform edits on the image, perform edits on a video, etc.

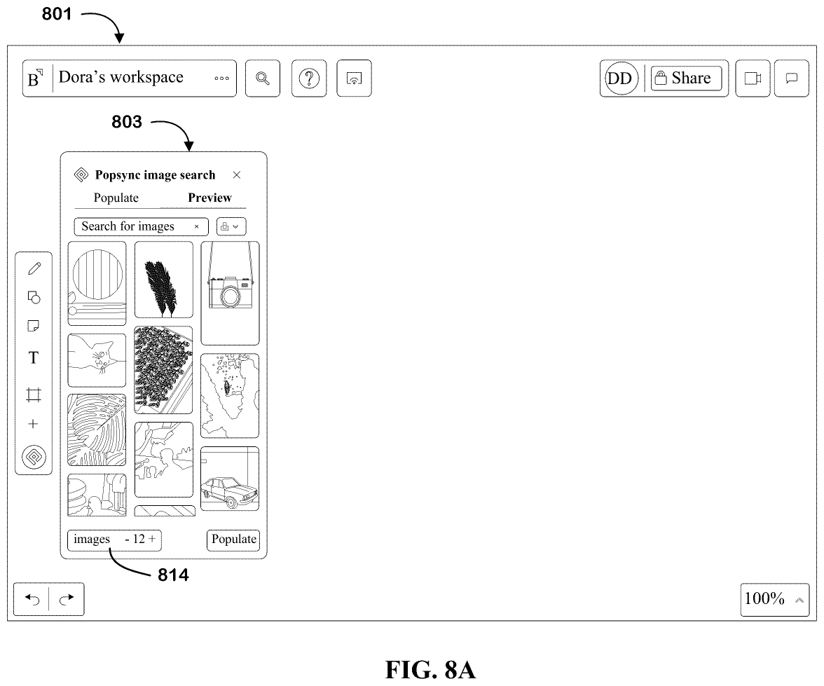

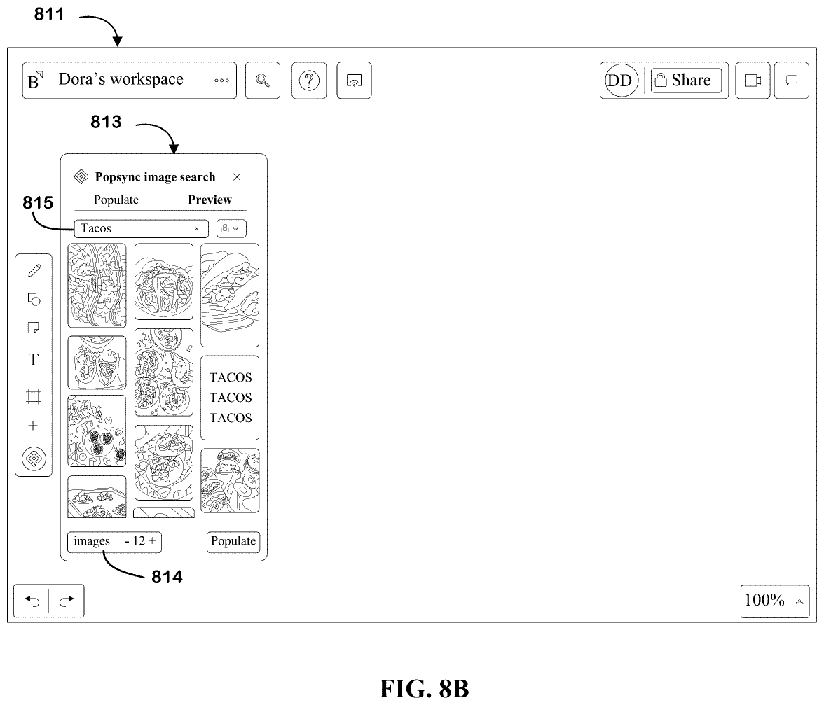

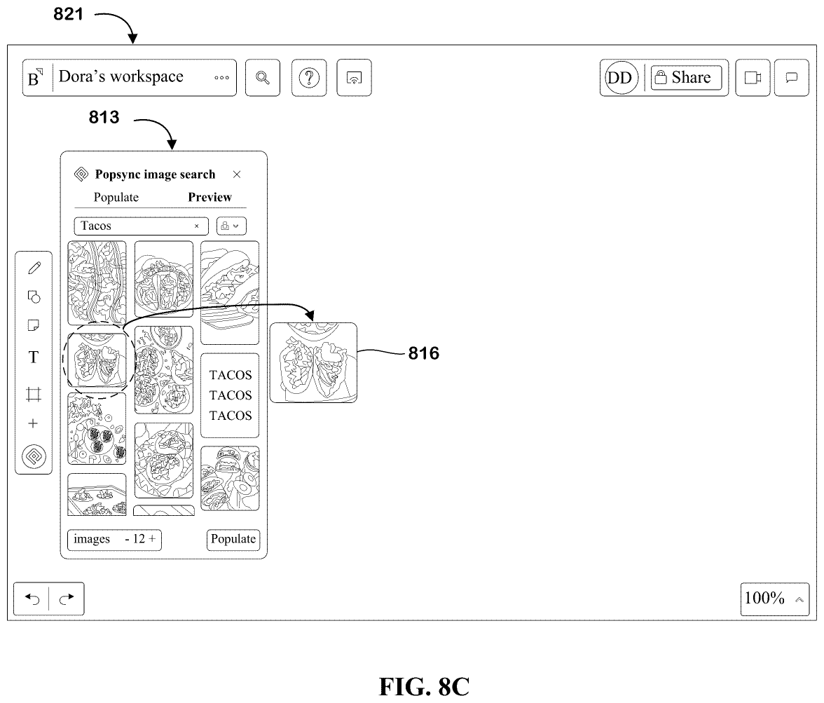

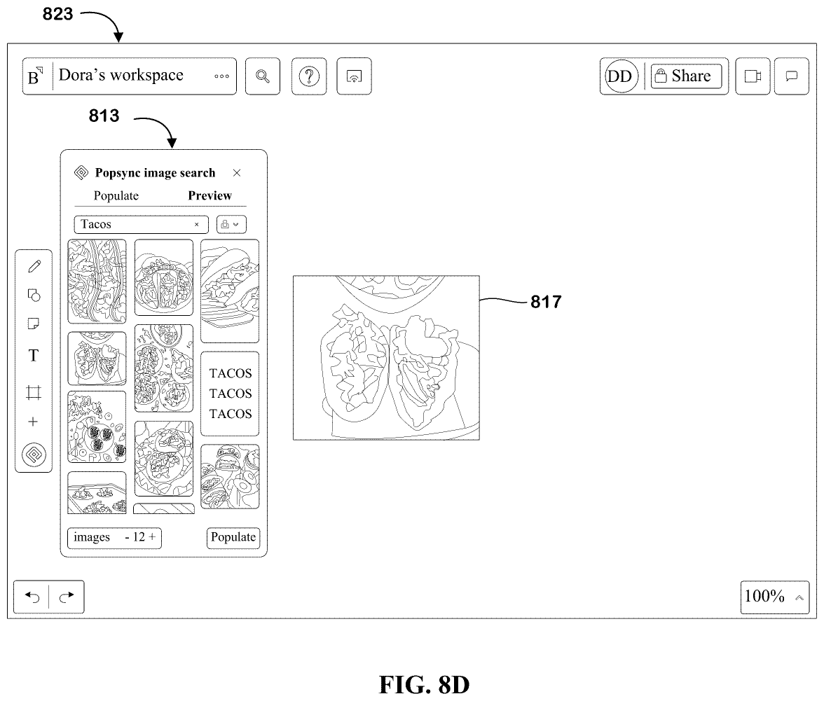

FIGS. 8A to 8D present a drag and drop functionality that allows a user to select one or more digital assets from search results presented in a canvas for moving to another location on the canvas or another location on the workspace. The selected digital assets can be dragged and dropped (or copied) to a desired location on the workspace.

FIG. 8A presents a user interface 801 that includes a canvas 803 displaying search results or digital assets. Note that these search results are randomly generated as no search keyword has been provided by any participant of the collaboration session. Therefore, the search results include digital assets related to various topics such as animals, plants, cars, cameras, etc. As opposed to being random, the digital assets can be searched, located and/or displays based on other information that is gather from the workspace and/or other related workspaces. The number of displayed images can be adjusted using interface element 814.

FIG. 8B presents a user interface 811 that includes a canvas 813. The canvas 813 is populated with search results received from one or more sources of digital assets. The search results are generated using a search keyword “tacos” entered by a user in the text input box 815.

FIG. 8C presents a user interface 821 that includes the canvas 813. A digital asset 816 is dragged and dropped to a location outside the canvas 813. The initial location of the digital asset 816 is shown in a broken circle in the left column of the canvas 813.

FIG. 8D presents a user interface 823 that includes the canvas 813 from which a user has dragged and dropped a digital asset 817 on a location on workspace outside of the canvas. The user can then manipulate and/or edit the digital asset 817 as needed. For example, the size of the digital asset 817 is increased as shown in FIG. 8D.

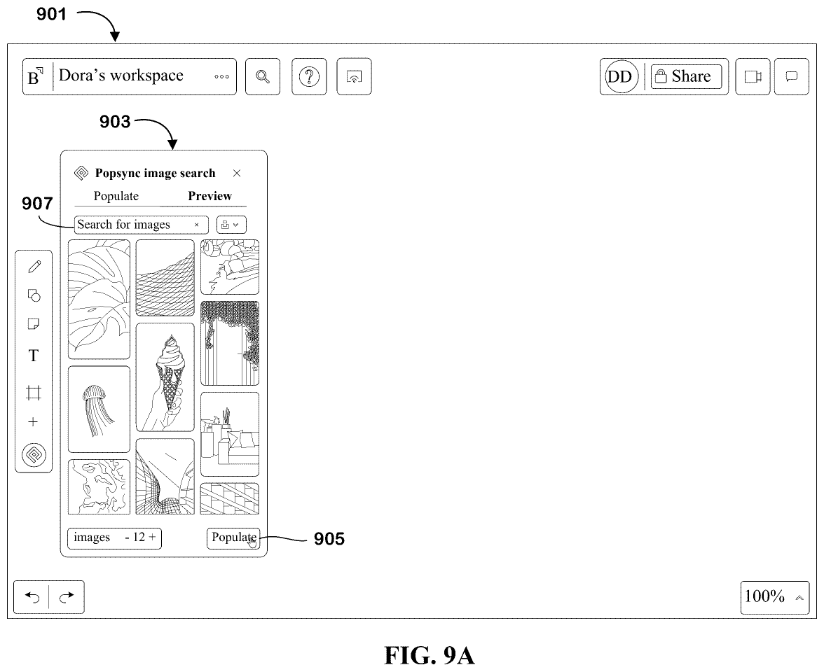

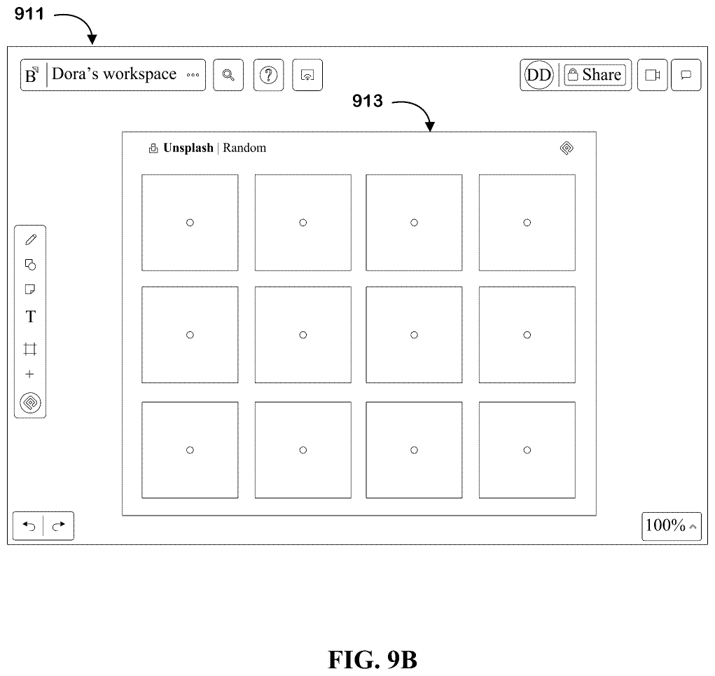

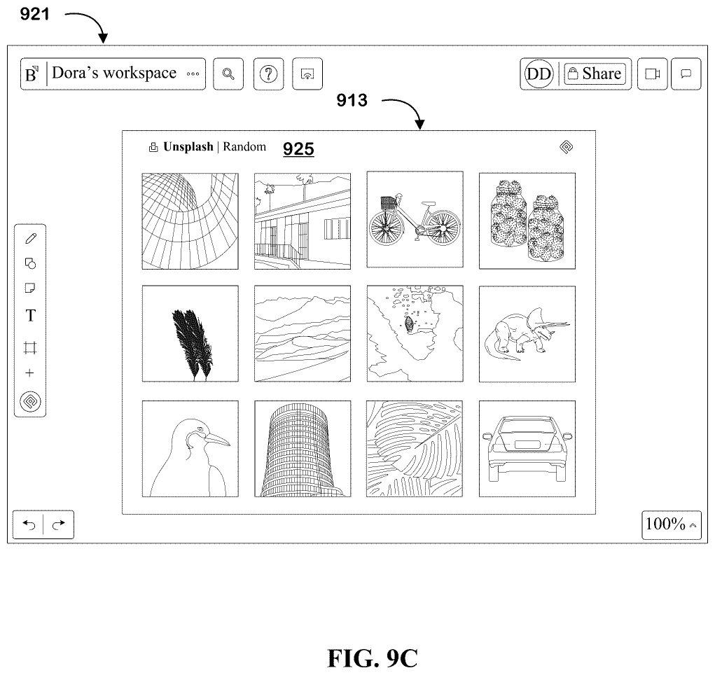

FIGS. 9A to 9C present population of a canvas (or a section) by generating random search results.

FIG. 9A presents a user interface 901 that includes a search dialog box 903 to search digital assets from sources of digital assets. A user can select a user interface element 905 to initiate search for digital assets. One or more search keywords can be entered in the input box 907. When no search keywords are entered in the input box 907 then a source of digital assets can generate random search results that can be related to various topics. In one implementation, the search results can be generated based on search keywords entered by a user in one or more prior collaboration sessions. In one implementation, the collaboration server can use signals from other sources such as keywords selected from video collaboration, audio collaboration or from chat session to provide random search keywords for generating the search query.

FIG. 9B presents a user interface 911 including a canvas 913 that includes placeholders for placing search results as they are received from one or more sources of digital assets. Currently, the placeholders in the canvas 913 are empty as search results are not yet received from the one or more sources of digital assets. The placeholders are arranged in a matrix format in the canvas 913. Other arrangements of placeholders can be used based on a selected template or a customize format provided by a user.

FIG. 9C presents a user interface 921 that includes the canvas 913 from the FIG. 9B. The placeholders in the canvas 913 as shown in FIG. 9B are now replaced with search results received from a source of digital assets. The search results are random as no search keyword was provided when the search was initiated (see FIG. 9A). The label 925 on the canvas 913 provides the name of the source of the digital assets from where search results are received. The label 925 also presents a search keyword that was included in the search query to generate search results. The search keyword is “random” which is set as default search keyword when no search keyword is entered by the user. It is understood that other default search keywords can set by an organization or an administrator or a meeting owner or a user. Such keywords can be used in the search query when no search keyword is provided by a user for searching the sources of digital assets or digital asset management systems. The search results presented in the canvas 913 are randomly generated and represent various topics such as buildings or architecture, animals, cars, plants, maps, natural scenes, bicycles, bottles, etc.

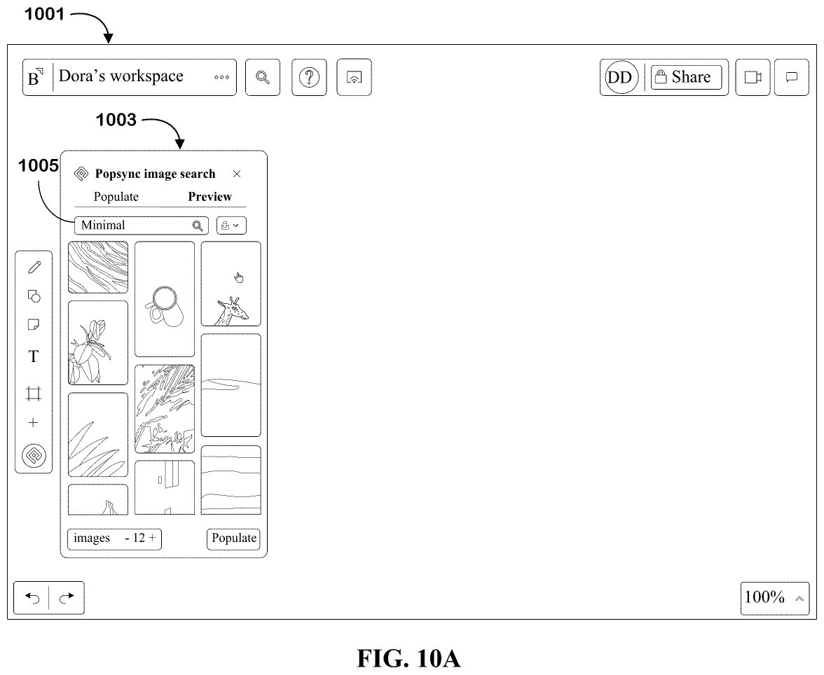

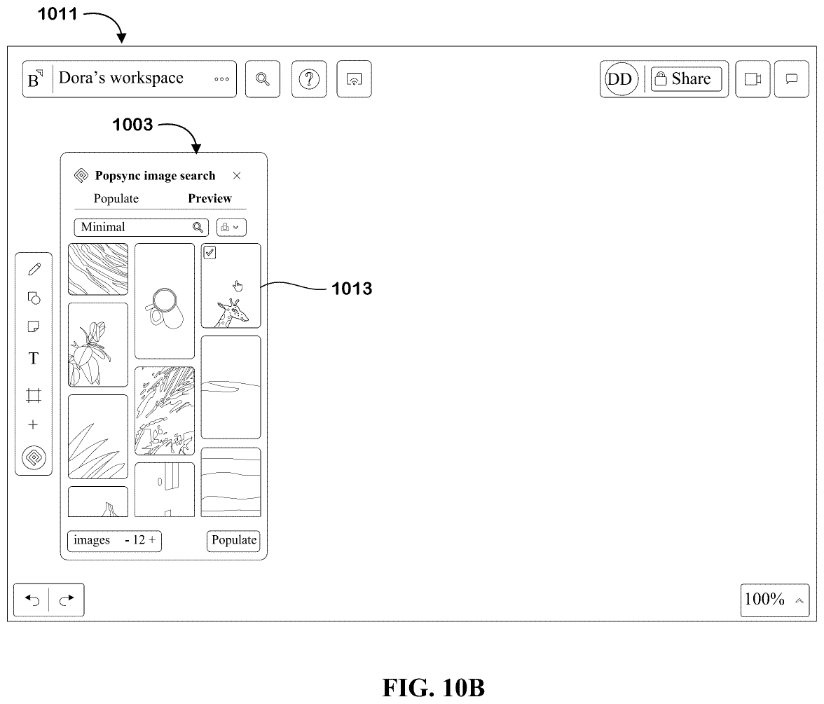

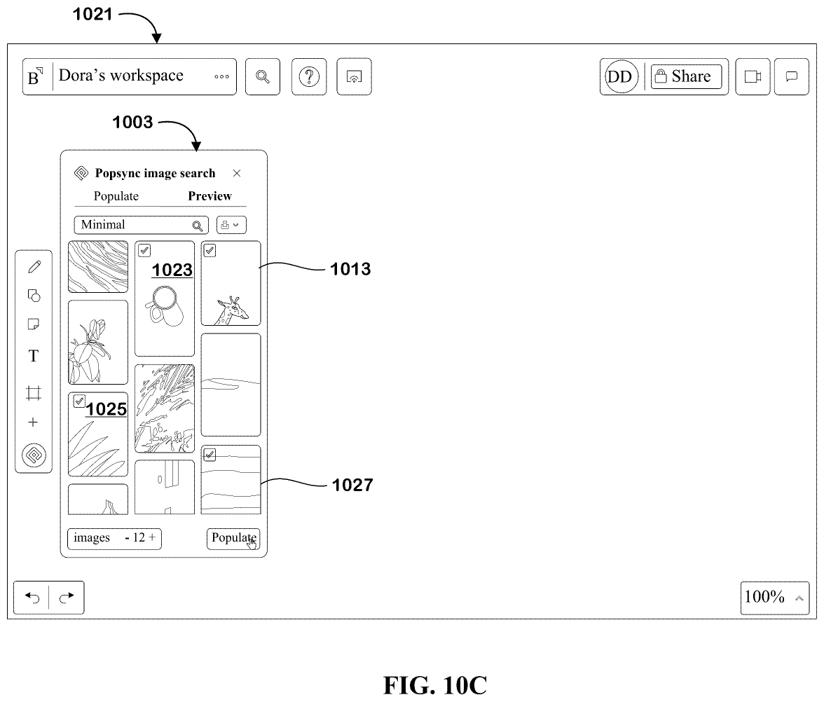

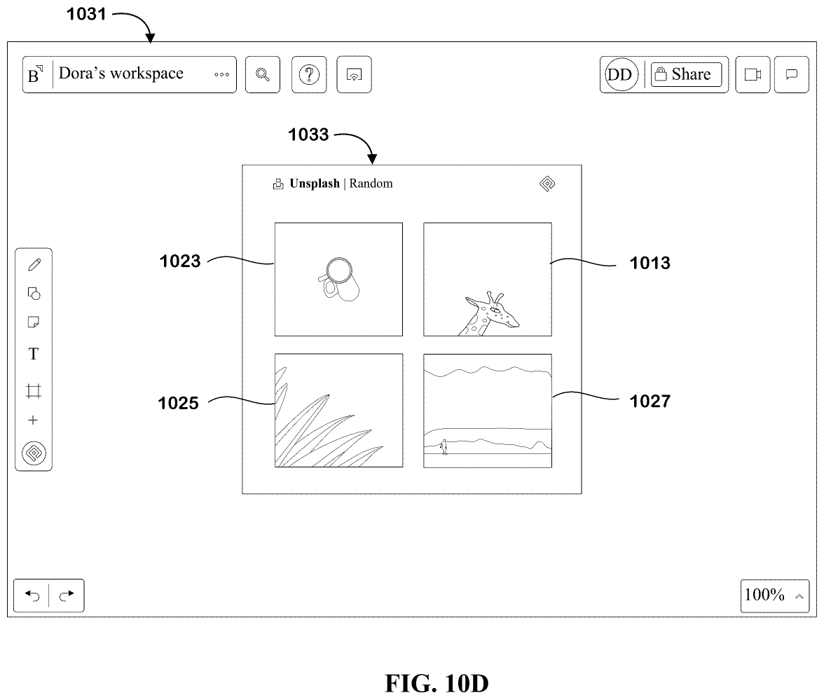

FIGS. 10A to 10D present a feature of the technology disclosed in which one or more search results can be selected and used to populate a new canvas.

FIG. 10A presents a user interface 1001 including a canvas 1003. The search keyword entered by the user is “minimal” in the input box 1005 within the search dialog box displayed on the top portion of the canvas 1003. The search results are presented in the canvas 1003 and are arranged in three columns.

FIG. 10B presents a user interface 1011 including the canvas 1003 displaying the search results (or digital assets). A user can select digital assets displayed in the canvas 1003 for further review or for sharing with one or more other users. The selected digital assets are displayed with a checkmark. For example, the user has selected a digital asset 1013 displayed in the canvas 1003 as illustrated in FIG. 10B.

FIG. 10C presents a user interface 1021 in which further digital assets are selected in the search results displayed in the canvas 1003. The selected digital assets 1023, 1025 and 1027 include a checkmark on the top indicating that these digital assets are selected for further processing.

FIG. 10D presents a user interface 1031 including a canvas 1033 displaying the selected digital assets 1013, 1023, 1025 and 1027. These four digital assets (1013, 1023, 1025 and 1027) were selected by one or more users of the collaboration session as shown in Figures 10B and 10C. The selected digital assets as displayed in canvas 1033 can be shared with one or more other users via email or other communication methods. Other operations can be performed on selected digital assets as desired e.g., the selected digital assets can be sent to another workspace for sharing with another team.

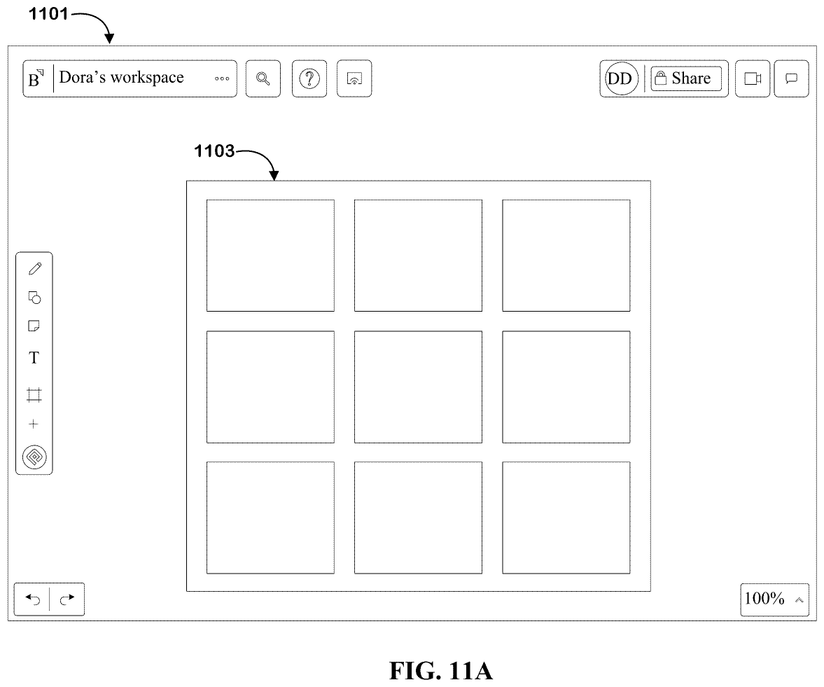

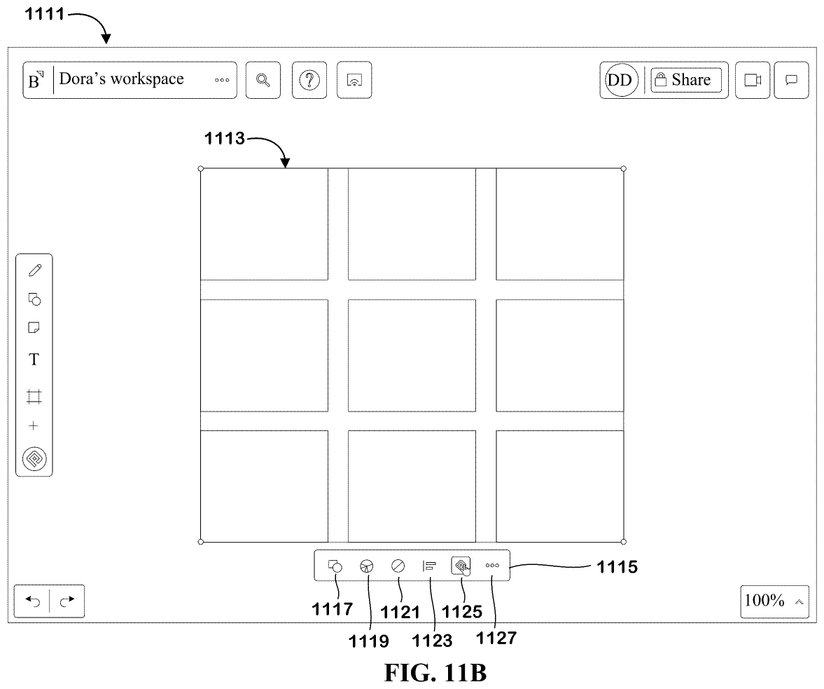

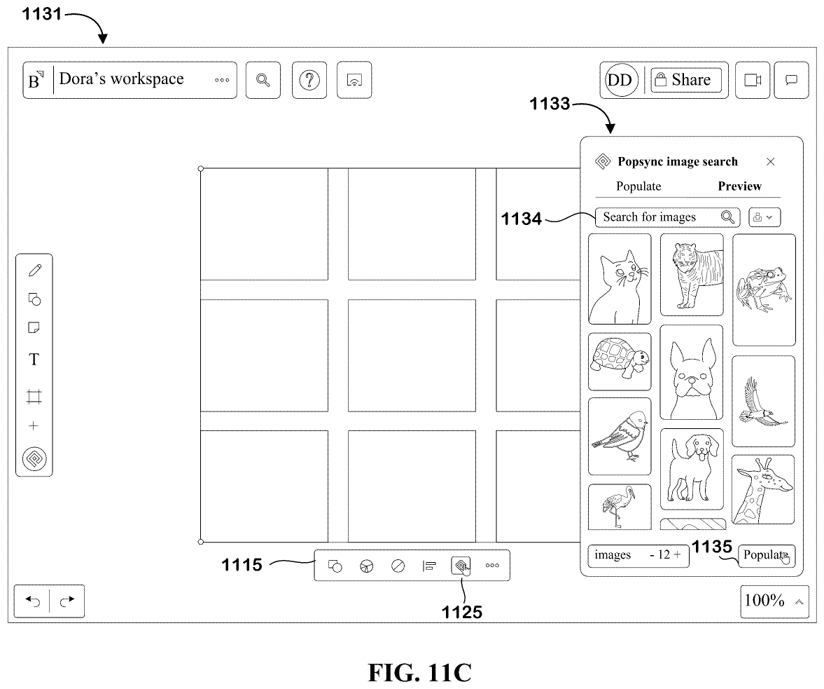

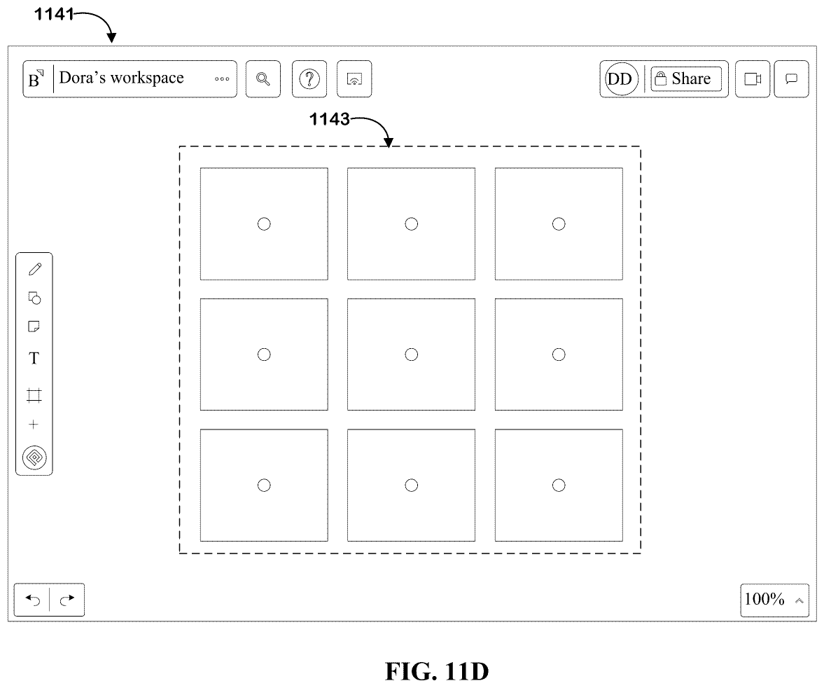

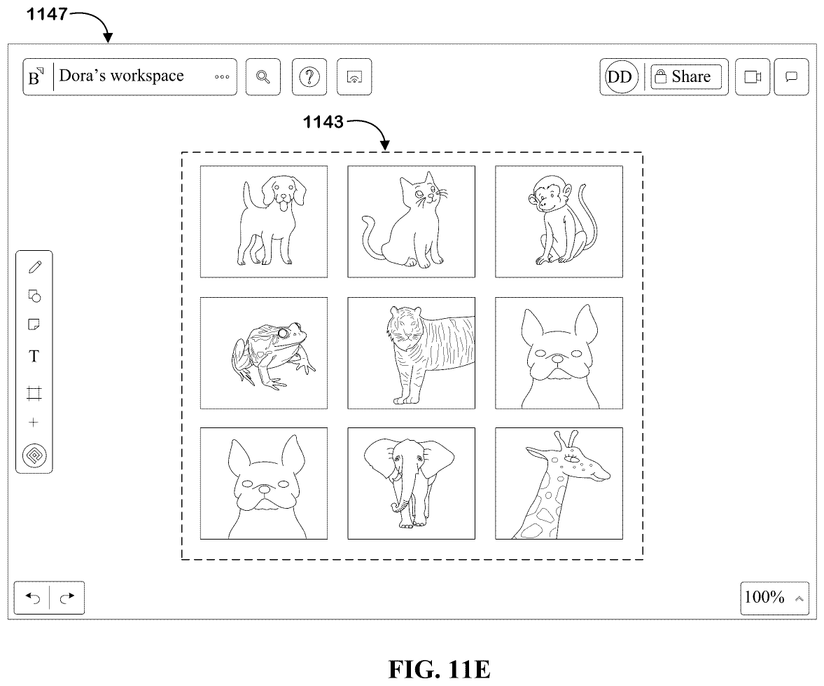

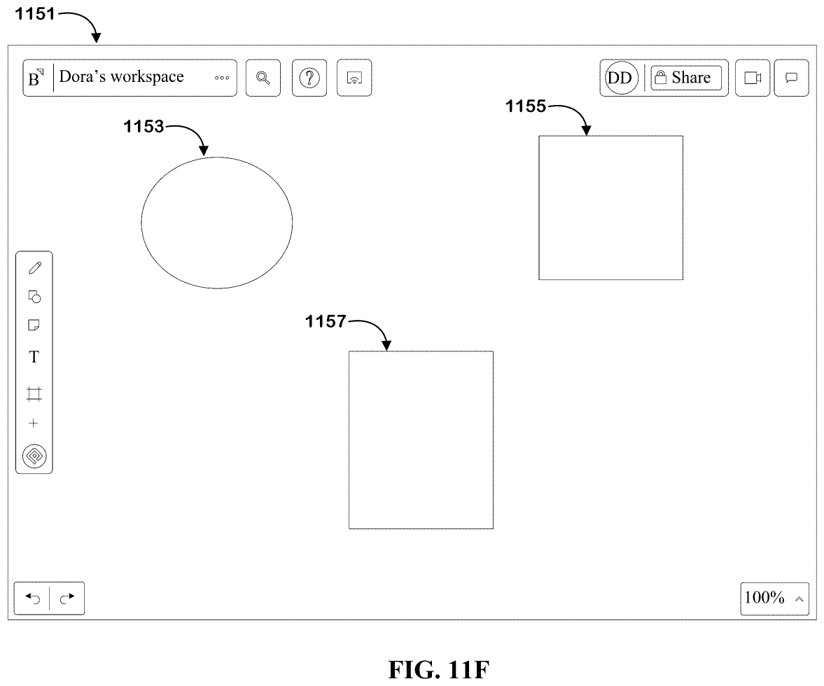

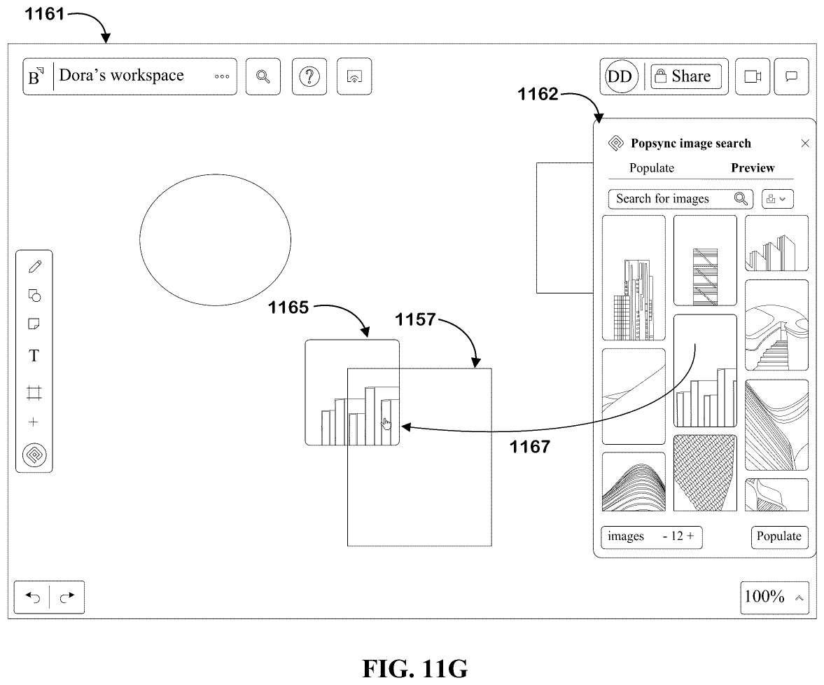

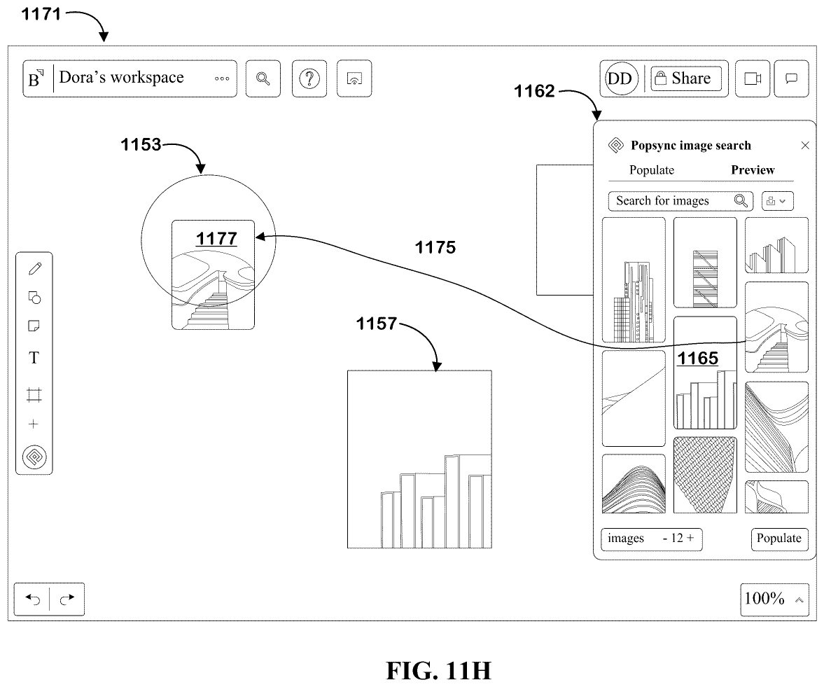

FIGS. 11A to 111 present selection of digital assets and placement of selected digital assets in various geometrical shapes and templates.

FIG. 11A presents a user interface 1101 that includes a canvas 1103 with pre-defined geometrical shapes arranged in a 3×3 matrix (i.e., three rows and three columns). The technology disclosed allows users to select pre-defined templates or create custom templates with pre-defined geometric shapes that can be randomly placed on the canvas (or the workspace) or arranged in patterns such as a matrix pattern (including rows and columns), a circular pattern, a honeycomb pattern, etc.

FIG. 11B presents a user interface 1111 including a canvas 1113 in which the search results can be displayed. The canvas 1113 includes a matrix pattern with placeholders arranged in rows and columns. The placeholders are replaced by search results when the search results are received from the one or more sources of digital assets. FIG. 11B also includes a toolbar 1115 that includes tools or controls to create and edit templates for displaying search results on a workspace. For example, a control 1117 can be selected to create various types of geometrical shapes (e.g., circles, square, triangle, rectangle, etc.). The search results can be placed in such geometrical shapes. A control 1119 is a color selection tool or color selection palette that can be used to select color schemes for templates. The selected colors can be applied to background, borders, or other regions of the template. A control 1121 can be used to create pie chart type graphical format templates for displaying search results. A control 1123 can be used to select a bar chart type format for templates. The control 1125 can be used to start a new search for digital assets. This control brings up the dialog box to provide search keywords and selection of sources of digital assets for conducting the search. The control 1127 can extend the toolbar 1115 or display additional controls or tools. The additional tools are related to editing and customizing the templates for displaying the search results or digital assets.

FIG. 11C presents a user interface 1131 that includes a search dialog box 1133 displayed on the workspace in response to the selection of the control 1125 on the toolbar 1115. A user can enter search keywords in the input text box 1134 and select the “populate” button 1135 to initiate the searching of digital assets from sources of digital assets.

FIG. 11D presents a user interface 1141 that includes a template 1143. The template 1143 comprises rows and columns of placeholders that will be replaced by search results as the results are received from sources of digital assets.

FIG. 11E presents a user interface 1147 that displays search results received from one or more sources of digital assets in the template 1143. The placeholders in the template as shown in FIG. 11D are replaced by search results (or digital assets) received from the sources of digital assets. In some cases, the placeholders can be filled in by the search results and boundaries of placeholders encompass the respective digital assets.

FIG. 11F presents a user interface 1151 that shows three geometrical shapes 1153, 1155 and 1157. The geometrical shapes can be added to the workspace for placing search results. A geometrical shape can be filled by one or more search results (i.e., digital assets). The geometrical shapes can be added to the workspace using the toolbar 1115 as shown in FIG. 11B.

FIG. 11G presents a user interface 1161 that includes a user interface element 1162 including search results (or digital assets) arranged in three columns. The top portion of the user interface element 1162 includes a text box for search keywords. The bottom portion of the user interface element displays search results received from one or more sources of digital assets. A user can drag and drop one or more digital assets in a geometrical shape (or a placeholder) located on the workspace. For example, a digital asset 1165 is dragged (or copied) from the user interface element 1162 and dropped (or placed or pasted) on the geometrical shape 1157. The drag and drop gesture of the digital asset from the user interface element 1162 to the geometrical shape 1157 is indicated by a path 1167 on FIG. 11G. The digital asset may be placed on a location such that it is only partially overlapping the geometrical shape or the placeholder. The technology disclose can also support other types of gestures on search results or digital assets. For example, drawing a circle or a boundary around digital assets can group the digital assets. A user can then use another gesture such as a check mark on a location within the drawn circle or the boundary causing the group of search results to be sent to one or more users via email. A compose email window can pop up on the workspace allowing the user to enter email addresses of recipients. Drawing (or annotating) a cross on a search result can remove the search result from the canvas. Annotating certain symbols or words on one or more search results can invoke workflows that can pass the selected digital assets to other teams or other departments within an organization.

FIG. 11H presents a user interface 1171 that shows the digital asset 1165 dragged and dropped to the geometrical shape 1157. As shown in FIG. 11G, the search result (or digital asset) 1165 is dragged and dropped at a location on the workspace that partially overlaps the geometrical shape 1157. The technology disclosed automatically adjusts the size of the digital asset 1165 to match the size of the geometrical shape 1157. In another instance when multiple search results or multiple digital assets are dragged and dropped at a location that overlaps a geometrical shape then all such digital assets are arranged within the geometrical shape. The template for arrangement of digital assets in a geometrical shape can be selected or defined by a user. FIG. 11H shows another search result (or digital asset) 1177 dragged (or copied) and dropped (or placed or pasted) at a location on the workspace that overlaps the geometric shape 1153. The search result (or digital asset) is dragged or copied from search results displayed in the user interface element 1162. A path 1175 indicates the drag and drop gesture performed by a user to copy the digital asset 1177 from a source location in the user interface element 1162 and place the digital asset at a target location on the workspace.

FIG. 11I shows a user interface 1181 that illustrates search result (or digital asset) 1177 dragged and dropped on the geometrical shape 1153. The geometrical shape 1153 is a circular shape while the digital asset 1177 is in a rectangular frame. The technology disclosed automatically resizes and reshapes the digital asset to conform the digital asset to fit within a target geometrical shape.

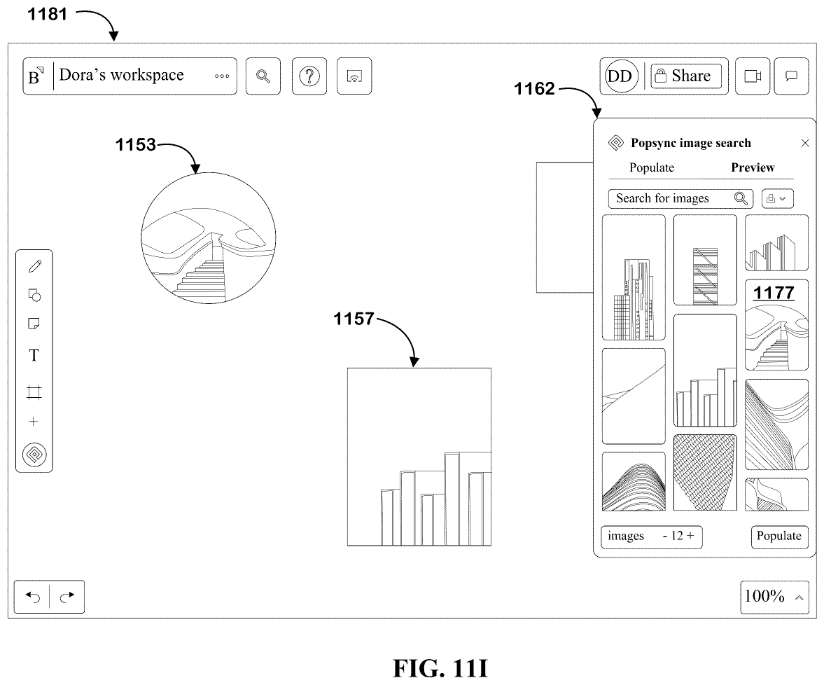

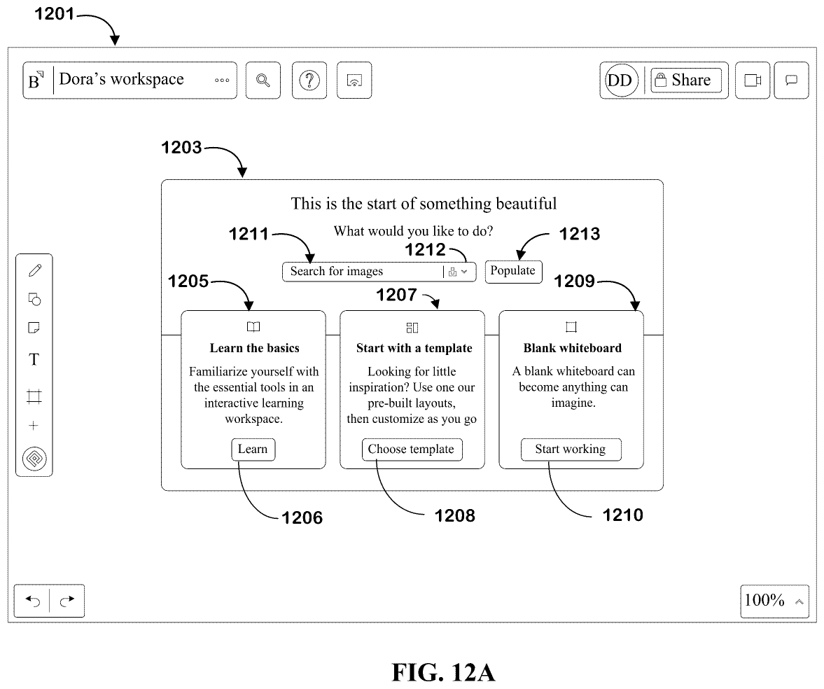

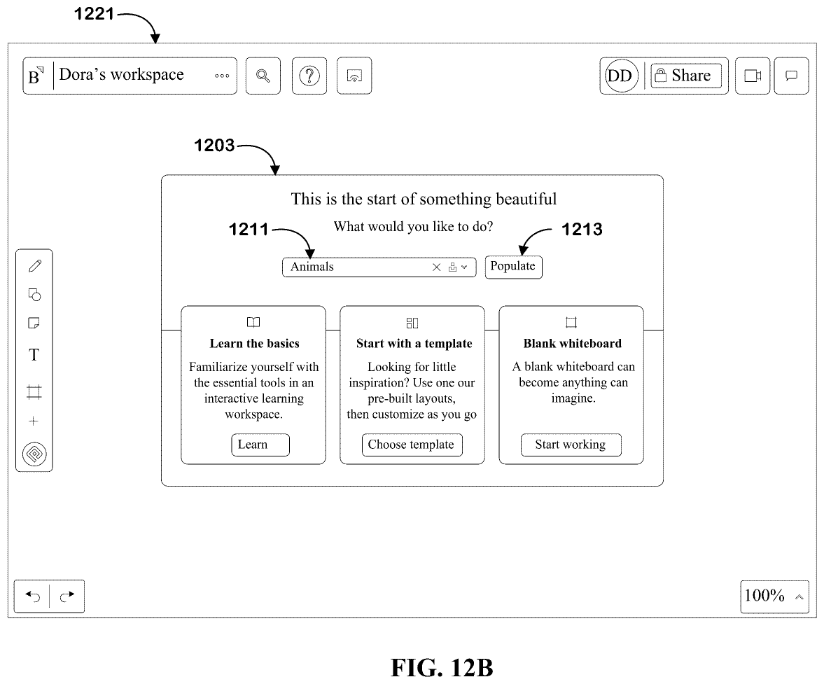

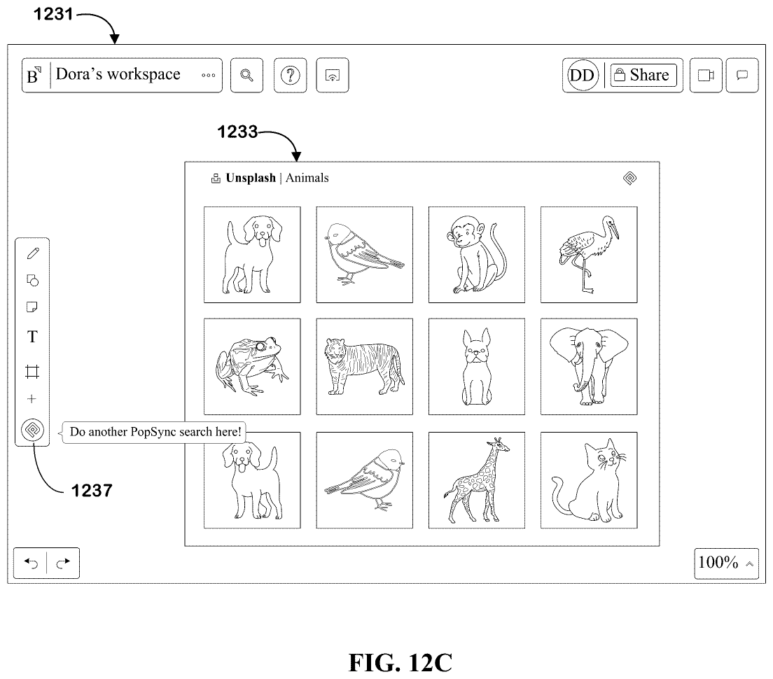

FIGS. 12A to 12C present another implementation of the technology disclosed to search sources of digital assets.

FIG. 12A presents a user interface 1201 that includes a user interface element (or a dialog box) 1203. The user interface element 1203 includes an input text box 1211 to receive inputs from users such as search keywords. A user interface element 1212 allows the users to select one or more sources of digital assets from which the digital assets will be searched in dependence on the search keywords. A user interface element 1213 can be selected to start searching of the sources of digital assets. A user interface element 1205 provides tutorials to users of the collaborative search tool. The users can select a user interface element (or button) 1206 to view the tutorials and access other learning materials related to use of the collaborative search tool. A user interface element 1207 provides the users access to pre-defined (or pre-built) templates for presenting or displaying search results on the workspace. The users can select a user interface element (or button) 1208 to access the pre-defined templates and to customize the templates according to their needs. A user interface element 1209 allows the user to start an online whiteboarding session without the use of any templates. The users can work collaboratively on the whiteboard by selecting a user interface element (or button) 1210. During the collaboration session, one or more users can select a control (or a button) provided on the user interface to invoke the search dialog box and start searching the sources of digital assets.

FIG. 12B presents a user interface 1221 that includes the dialog box 1203. A search keyword “animal” is entered into the input text box 1211. A user can select the user interface element 1213 to start the search.

FIG. 12C presents a user interface 1231 that includes a canvas 1233 displaying search results in a matrix format (i.e., arranged in rows and columns). A new search can be started by selecting a user interface element 1237.

### Server-Side Process for Searching Digital Assets

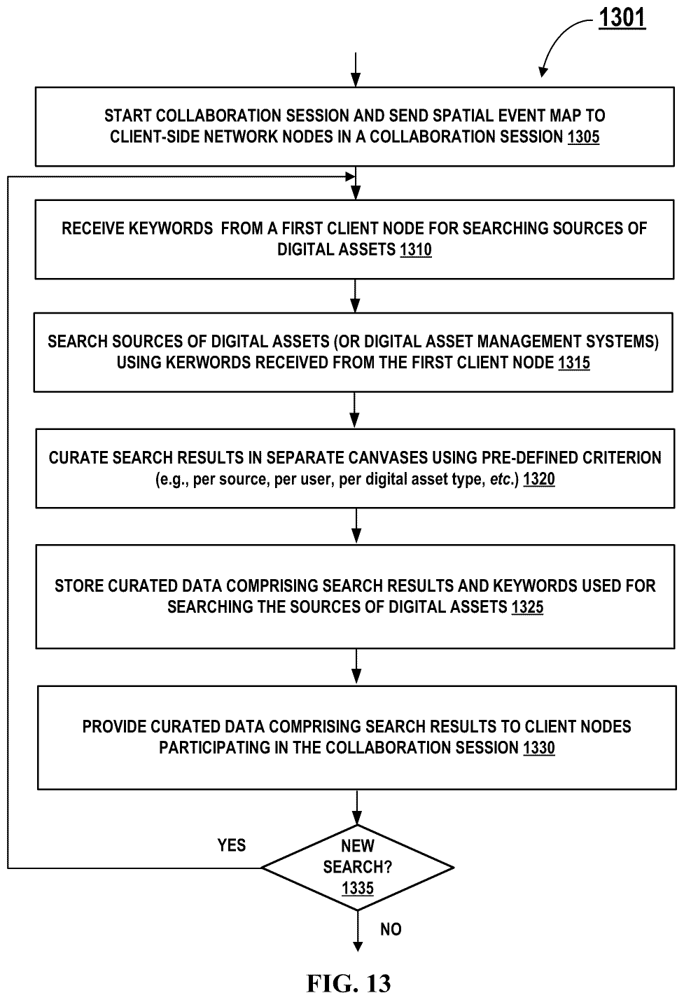

FIG. 13 is a simplified flow diagram 1301 presenting operations performed by a server node (also referred to as a server or as a collaboration server).

The order illustrated in the simplified flow diagram 1301 (in FIG. 13) is provided for the purposes of illustration, and can be modified as suits a particular implementation. Many of the steps, for example, can be executed in parallel. Some or all of the spatial event map can be transmitted to client nodes of participating users. The determination of what portions of the spatial event map are to be sent can depend on the size of the spatial event map, the bandwidth between the server and the clients, the usage history of the clients, the number of clients, as well as any other factors that could contribute to providing a balance of latency and usability. The workspace can be, in essence, limitless, while a viewport for a client has a specific location and dimensions in the workspace. A plurality of client nodes can be collaborating within the workspace with overlapping viewports. The client nodes can receive and log the events relating to the digital assets that have coordinates outside of their viewport.

The process in FIG. 13 starts by establishing a collaboration session between client nodes. The server node (or collaboration server) sends the spatial event map or at least a portion of the spatial event map to client nodes participating in the collaboration session (operation 1305). The server node receives data from a first client node (operation 1310). The data can include one or more keywords for searching the sources of digital assets. The server node can receive the data in an update event. The update event can be sent by the first client node to the server node. The update event can include the search keywords and additional data required for the searching the sources of digital assets. Such additional data can include identifiers, names, labels, locations or links (such as uniform resource locators) of sources of digital assets selected for searching the digital assets. The update event can also include any credentials such as a username and/or password, a biometric identifier of the user or another type of identifier of the user required to access a digital asset management (DAM) system that is accessible to users who are authorized to access the DAM. The technology disclosed also allows users to access privately available sources of digital assets (such as images, videos, source code, product designs, user interface designs, architectural designs, two-dimensional or three-dimensional models, etc.). The user is required to provide their access credentials to access such private sources of digital assets. In one implementation, the credentials of the user are received, by the server node from the client node, in a separate message or a separate event and are not sent along with search keywords by the first client node in the update event. Examples of sources of digital assets include Getty Images™, Shutterstock™, iStock™, Giphy™, Instagram™, Twitter™, etc. Users can join a collaborative search session as anonymously or as guest users without providing any credentials. Therefore, the technology disclosed does not require the users to register or create an account before using the collaborative search technology.

The server node can then initiate the search by passing the search keywords to one or more sources of digital assets or digital asset management systems (operation 1315). The sources of digital assets can send back the search results to the server node. The server node can download the search results or at least a part of the search results (or digital assets) from the respective servers that host (or store) these digital assets. In one implementation, the search results can be ephemeral (or temporary). The search results are not stored to the storage linked to the server node as the search results are received from sources of digital assets. The search results are placed in the spatial event map and distributed to client nodes. The curated and selected search results are then stored in a storage and remaining search results can be discarded.

The server node includes logic to curate the search results to facilitate the review of search results by participants in a collaboration session (operation 1320). The curation can be performed based on pre-defined criteria. For example, the server node can arrange the search results in separate canvases per source of digital asset. In this case one canvas (or section) displays search results from a single source of digital assets. When multiple users are searching the digital assets in a collaboration session by providing respective search keywords, server node can arrange the search results in a canvas per user. This facilitates review of each participant's work as each participant's search results are presented in a separate canvas. The search results can also be arranged based on the type of digital assets. For example, images, videos, PDF documents, presentation slide decks, source code, web pages, etc. are arranged in separate canvases to facilitate review of digital assets. It is understood that additional criterion can be defined for curating digital assets. In one implementation, a trained machine learning model can be used to classify digital assets in different classes. The machine learning model can be trained to classify the search results based on a type of the digital asset, or based on content, etc. The digital assets are automatically arranged in various canvases (or sections).

The server node can store the curated digital assets in a storage, for example, a local storage drive linked to the server node or a cloud-based storage accessible via the Internet (operation 1325). Storing the search results (or digital assets) on a storage helps the technology disclosed to share the search results with client nodes using a spatial event map. The client nodes do not need to access the external web servers or external resources to access the search results. Additionally, the same search results are available to all users irrespective of their geographic location or distance from other users. Therefore, the technology disclosed enables ease of searching, sharing and review of digital assets.

The server node includes logic to provide the curated search results to the client nodes of users participating in the collaboration session (operation 1330). The user can review the search results and further curate and/or select digital assets. The curated and selected digital assets can then be stored for further review and remaining search results may be discarded. The technology disclosed allows multiple users to collaboratively work to review and curate the digital assets. The technology disclosed also include presence awareness markers that indicate the location of each user on the workspace. This allows users to know the locations (or canvases) on which other users are working during review and curation process.

The server node can receive one or more new search keywords, if a participant needs to perform a further search of the sources of digital assets (“yes” branch of operation 1335). The process then repeats the operations described above starting from operation 1310. Otherwise, the search process ends following the “no” branch of operation 1335.

The search, review and curation process can be performed iteratively to refine the search results. Multiple users can collaboratively work in this iterative process. The users can select, edit or annotate search results. They can add comments on the digital assets or add annotations for other participants to review. Chat sessions can be initiated from within the virtual workspace during these search and curation session to facilitate the process. A final curated set of searched digital assets can be saved and used for further collaboration, sharing, project management, etc. Any number of users or participants can join the collaborative search and curation of digital assets. Registered and non-registered users (such as guest or anonymous) users can work together in search and curation of digital assets. Each user can also save their individual search and review results in a separate container such as a canvas for further work in a next collaboration session. The technology disclosed can be used in enterprise collaboration environments during projects that require collaborative search and curation of digital assets such as in development of new product ideas, user interface design, film production such as production of animated movies, etc. The technology disclosed can be used in search, review, curation and organization of digital assets for enterprise collaboration projects. The technology disclosed can be used in brainstorming sessions which are carried out in the beginning of any project whether it is a small project or a large project involving multiple teams. Therefore, the technology disclosed is useful both in an enterprise project management environment involving tens or hundreds of users as well as for an individual user's project which may involve a few other users.

### Finding Similar Digital Assets Using a Sharable Container

The technology disclosed enables users to find digital assets that are similar to a digital asset that is selected from a current or a previous search. The “similar digital assets” can be found by searching various sources of digital assets such as search engines, public and private repositories or digital assets, digital asset management (DAM) systems, etc. The search results are presented in a sharable container (such as workspace) for further review and curation by participants of the collaborative search session. During a collaboration session, suppose a participant selects one digital asset (such as an image, etc.). The participant can then initiate a “search similar” or “find similar” function for the selected digital asset. The technology disclosed provides an efficient way to search similar digital assets by enabling the users to select a digital asset in the sharable container and then select a user interface element (such as a button, link, etc.) to initiate the “search similar” or “find similar” function. A participant can select two or more (e.g., three, four, five, etc.) digital assets and initial the “search similar” or “find similar” function. When two or more digital assets are selected, the technology disclosed can perform the search similar functionality in two ways. In a first implementation, the technology disclosed determines similarities amongst the multiple selected digital assets. The similarities are then used to search for similar digital assets. In such an implementation, trained machine learning models can be used to extract similar features from the multiple digital assets. These features can then be used to search sources of digital assets for similar digital assets. In a second implementation, the multiple digital assets (or portions of multiple selected digital assets) selected by the participants are provided in a search query to sources of digital assets for searching similar digital assets. The search results returned by the sources of digital assets are then arranged in separate canvases per searched digital asset. When searching for similar digital assets, a participant can select a limit on the number of search results to be displayed on the workspace. For example, a participant can select top one hundred (100) results to be displayed on the workspace. If the participant had selected four digital assets in the query for searching similar digital assets then twenty five (25) results for each of the four digital assets can be displayed on the workspace, totaling one hundred search results.

Users or participants of the collaboration session can customize the maximum number of search results displayed on the display screens linked to their respective client nodes. For example, in a particular search the collaboration server can receive ten thousand (10,000) search results from sources of digital assets (such as search engines, public and private repositories of digital assets and/or other digital asset management (DAM) systems). However, the collaboration server allows display of only pre-configured or pre-selected number of digital assets per client node according to the configuration or selection by respective participants. For example, consider participant A selected to view one hundred (100) digital assets from the search result. The collaboration server sends the update event to the spatial event map to display top one hundred search results (on display client linked to participant A's client node) received from the search engines or sources of digital assets. Suppose another participant B in the same collaboration session selected to view only twenty (20) search results then the collaboration server sends an update event to the spatial event map to display top twenty search results on the display linked to the client node of participant B from the search results received from search engines or sources of digital assets. If a user does not select or configure the number of search results to be displayed on the display screen linked to the client node associated with the user then collaboration server can use a default value for the upper limit or the maximum number of search results that can displayed on the display client linked to the client node associated with the user, such as, up to ten thousand (10,000) search results from the search results received from search engines or sources of digital assets. It is understood that only a portion of the search results (such as ten, twenty, fifty, etc.) are displayed in a canvas on the workspace depending on the size of the display linked to a client node. Users can scroll up-down and/or sideways to view further search results. Zoom size of search results can be increased or decreased that can also respectively decrease or increase the number of search results that can be view on the display screen.

This technology disclosed provides an efficient method to search similar digital assets as compared to existing search systems. The existing systems often require uploading of the digital asset (such as an image) to a search engine for searching similar images. The technology disclosed enables efficient performance of the search similar digital assets functionality as digital assets are already available in the sharable container and the user can select a digital asset to search the sources of digital assets for digital assets that match the selected digital asset. No download of a digital asset to a storage is required and no upload of the stored digital assets to a search engine is required to use search similar digital assets functionality. The user can select a search result and initiate “find similar” search. The technology disclosed therefore, provides a one click (or one step) “find similar” or “search similar” functionality. The technology disclosed can search one or more sources of digital assets to search for other digital assets that are similar to the digital asset selected in the sharable container.

Artificial intelligence and/or machine learning models can be trained and used in the implementation of the search similar digital assets feature. For example, the technology disclosed can incorporate a trained machine learning model to classify the digital assets in a workspace. The classification of the selected digital asset can be performed to classify the selected digital asset and then conduct a search for similar digital assets using the classification data. For example, if the trained machine learning model classifies a selected digital asset as belonging to a class labeled as “dog”, the technology disclosed can send the classification i.e., “dog”, of the selected image in a search query to the sources of digital assets. In one implementation, the technology disclosed can use a plurality of trained machine learning models to classify the image and sends the classification output by all or some of the machine learning models for the selected image. In another implementation, the technology disclosed sends the selected image in the search query to sources of digital assets. In another implementation, the technology disclosed sends the one or more classification outputs and the selected image to sources of digital assets for searching similar digital assets. In one implementation, the technology disclosed can send a portion of the digital asset to the search engine for searching similar digital asset. For example, a portion of an image can be cropped and sent to sources of digital assets with or without classification data to search similar digital assets.

The digital assets can be searchable documents or can comprise content that is searchable. For example, the digital assets can be images from groups of pixels can be selected for further searching sources of digital assets. The groups of pixels can represent shapes or objects of interest. The digital assets can be audio recordings from which key-phrases can be extracted for further searching of similar digital assets. The digital assets can be documents, slide decks, program codes, etc. from which key-phrases can be extracted for further searching of digital assets. The digital assets can be three-dimensional models from which parts or portions of a three-dimensional model can be extracted for further searching of similar parts in a repository of parts maintained by an organization.

The search results can be arranged in separate regions or sections on a workspace. The sections are also referred to as canvases. The canvases can be organized per source of digital assets and/or per user or participant of the collaborative search session. Search results from different users or participants can appear in the sharable container with respective names of users who have searched. The search results can be organized in canvases by identifiers of users and further for each user the search results can be organized in separate canvases for respective sources of digital assets.

The results of the “find similar” or “search similar” functionality can be viewed by all participants of the collaboration session. Multiple users or participants can perform “find similar” search in parallel from within the same sharable container. All participants can see not only their own search results but also search results for searches performed by other participants in the collaborative search session using the workspace i.e., the sharable container of digital assets. One or more users can collaboratively work on the digital assets such as by including mark-ups, annotations and/or comments on the digital assets. Other operations can also be performed such linking other digital assets or portions of other digital assets with the selected digital assets. For example, a selected slide from slide deck or a selected page from a document can be linked to a selected digital asset.

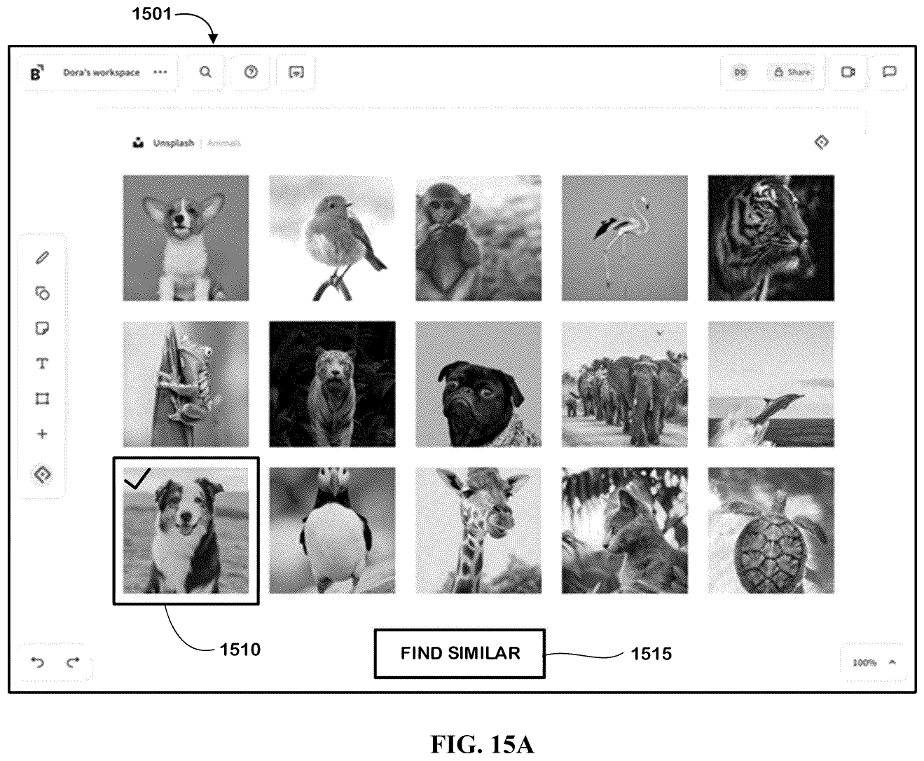

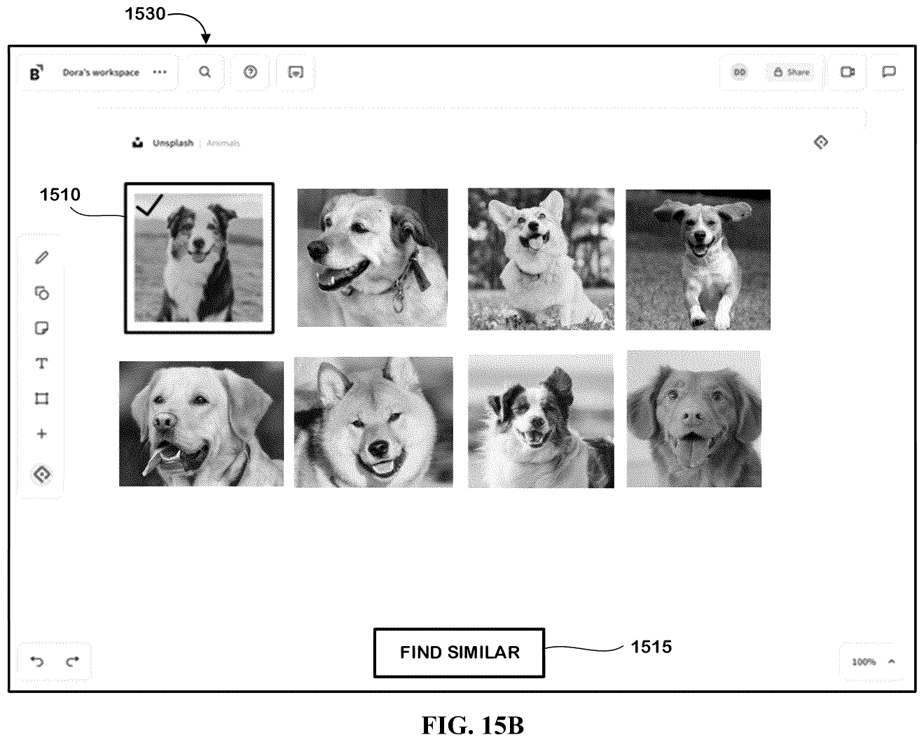

FIG. 15A shows results of a search using a keyword “Animals” as displayed on a user interface 1501 provided by the technology disclosed. A portion of the search results are displayed on the digital display. The users of the collaborative search session can scroll down to see more search results. The search has returned images of various animals. One of the users in the collaborative search session selects an image (1510) of a dog as indicated by a check mark and a highlighted box around the selected image. The user then selects “Find Similar” button (1515) displayed on the user interface 1501. The technology disclosed then initiates a find similar search using the selected image as a query image. The search process can include determine a class of the image using a trained machine learning model as described above. The selected image 1510 or a portion of the selected image can be sent in a search query to sources of digital assets for searching similar digital assets. The search query can also include a classification of the selected image as output by a trained machine learning model.

FIG. 15B presents a user interface 1530 displaying results of the “find similar” search as received from sources of digital assets in response to the search query including the selected digital asset and/or the classification of the selected digital asset as described with reference to FIG. 15A. The query image 1510 is positioned in the top left corner and similar digital assets returned from the sources of digital assets (or search engines) are displayed on the workspace. A user can select one or more digital assets from the search results and initiate a further “find similar” search by selecting the find similar user interface element 1515.

### Comparing Digital Assets Using a Sharable Container

The technology disclosed provides functionality to compare two or more digital assets. Suppose a user wants to compare two digital assets (such as images) in search results presented in the workspace. These digital assets can be from one canvas (i.e., from one source of digital assets) or from two different canvases (i.e., from two separate sources of digital assets). The digital assets searched by multiple users can also be compared in a similar manner. The technology disclosed can present a side-by-side comparison of the digital assets. The applications of the technology disclosed include comparison of digital assets (products) in an e-commerce application. Different variants of a products can be presented side-by-side for comparison. Comparison of two or more digital assets (such as images, architectural plans, user interface designs, 3D models, etc.) can be performed in the workspace just by selecting the digital assets and initiating a compare functionality. The two or more digital assets are presented side-by-side in an existing canvas or in a new canvas created in the workspace for presenting comparison of digital assets. The comparison of the digital assets can include identification of differences and/or similarities between the two digital assets. The differences and/or similarities can be highlighted graphically such as by marking the locations on digital assets that are different from the other digital asset. The differences and/or similarities can also be presented in a textual description including a brief description of the differences and/or similarities between the digital assets. A trained machine learning model can also be used for identifying differences and/or similarities between two digital assets. The two digital assets can be provided as input to the trained machine learning model. The trained model can output the differences and/or similarities between the two digital assets in a textual or a graphical manner. Users of the collaboration session can review the compared digital assets and contribute such as by providing comments, annotations, markups etc. Any user or participant of the collaborative search can perform the comparison on two or more search results.

Multiple users or participants can compare digital assets in parallel from within the same canvas and/or by selecting search results from different canvases that are from different searches initiated by different participants. All participants can see not only their own comparisons but also the comparisons performed by other participants in the collaborative search session on the workspace. As described above, the workspace is synchronized across client nodes using the spatial event map technology presented above. One or more users can collaboratively work on the compared digital assets such as by including mark-ups or annotations on the digital assets. Other operations can also be performed such linking other digital assets or portions of other digital assets with the selected digital assets. For example, a selected slide from slide deck or a selected page from a document can be linked to the selected digital asset. Search results can also be identified by names of participants, e.g., the participant who searched a particular digital asset. Therefore, when comparing digital assets side-by-side, the participants can know the identifier or name of the participant who searched the digital asset.

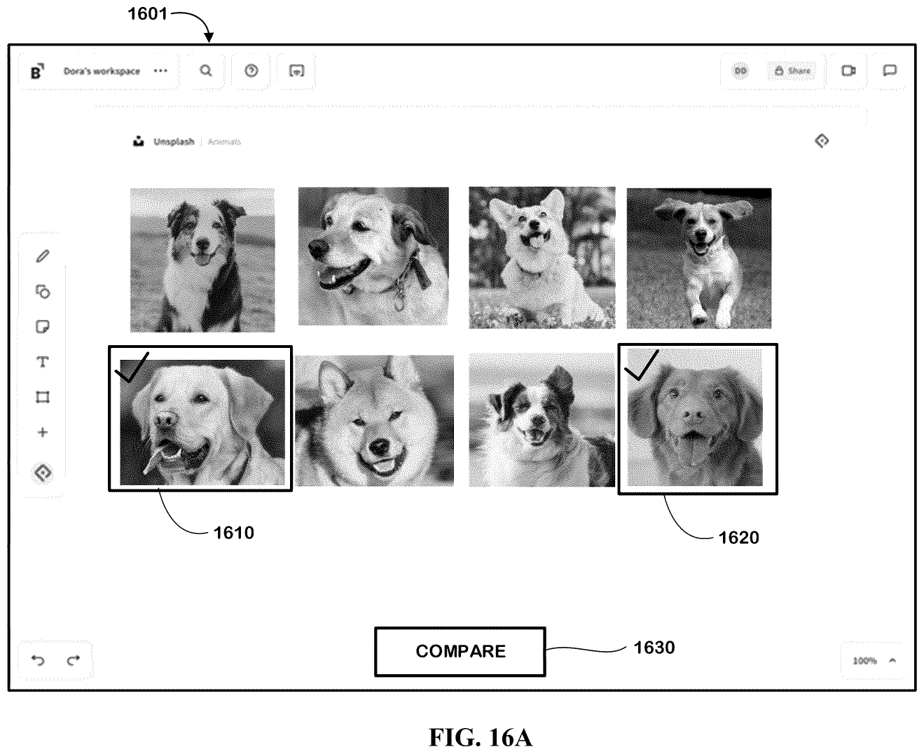

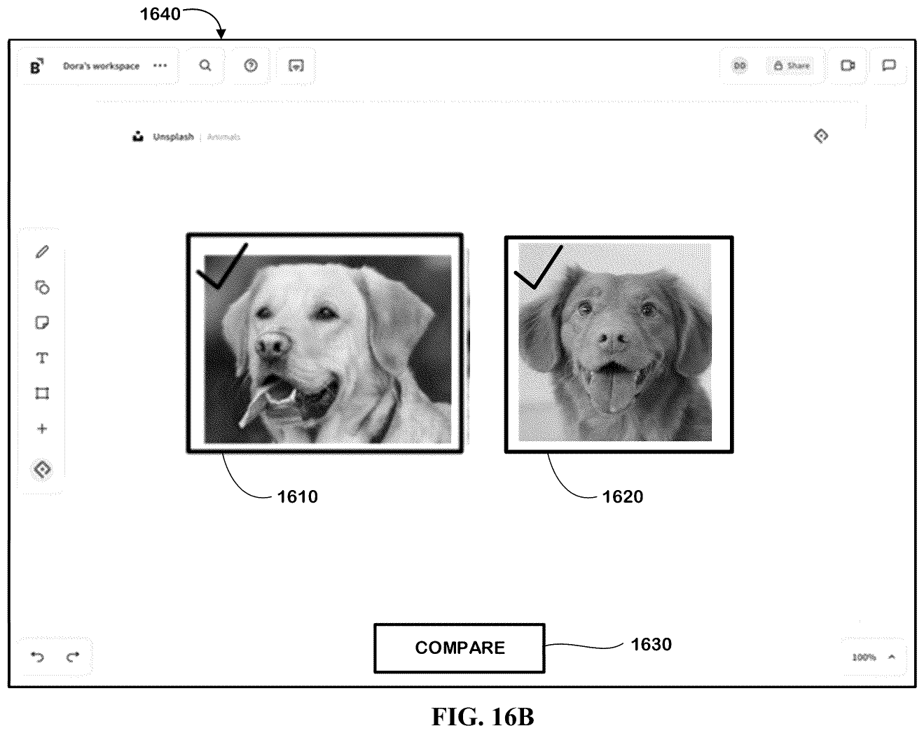

FIG. 16A shows two images (1610 and 1620) selected for comparison. The selected images are indicated by checkmarks on their top left corners and boxes positioned around the images, highlighting the images that are selected for comparison. The user can select a user interface element such as a “compare” button 1630 displayed on the user interface 1601 to compare the selected digital assets.

FIG. 16B present a user interface 1640 that illustrates the compare feature of the technology disclosed. The selected images 1610 and 1620 are presented in a new canvas for side-by-side comparison. The technology disclosed can present the images in a larger size for ease of comparison and review by users. The technology disclosed provides tools to users of the collaborative session to annotate on the images or add their comments, etc.

### Generating Persistent Search Results Using a Sharable Container

The technology disclosed can be used to generate persistent search results over serval time intervals. Existing search and metasearch technologies do not provide persistent search results. For example, when digital assets are searched using search engines, the search results can be shared by a user who performed the search with other users by either sharing a uniform resource locator (or URL) of the search results or a web page presenting the search results. However, this method of sharing search results does not guarantee that same search results will be presented to the user with whom the search results are shared when a search is performed using the URL or using the same search keywords as used by the user who performed the initial search. This is because the digital assets saved on various servers can change over time as new images, videos, text are indexed by the search engines and also some images, videos or text may be removed by respective servers where the digital assets were stored. In other words, the Google™ search that was performed on a Monday may provide different search results when performed on the following Friday even if search is performed using the same search keywords or same images, etc. The search results are not persistent because new data (e.g., digital assets) are being accessed by servers on a continuing basis. For example, based on the dynamic nature of digital assets saved on various servers, the results can change by the hour or even by the minute. In some cases, especially in situation awareness, it is desired (or even required) to have persistent search results. Persistent search results enable participants of a collaboration meeting to view how a situation is evolving over time.

The technology disclosed enables persistent sharing of digital assets using a sharable container of digital assets. A user can search for digital assets from sources of digital assets and then share persistent search results with other users or participants. The search results (i.e., images, videos, text, etc.) are downloaded and temporarily stored in the sharable container of digital assets which makes the searches performed by the technology disclosed as persistent.

For example, consider a user wants to see what is happening in a military zone. The user can perform a search and find results. For situation awareness scenarios such as in military zones, it is important to do the search in a persistent manner. A new search on the same situation, on a following day or even a few hours later is likely to generate new results. The persistent search results accumulated over time can then be compared by participants to see how situation has evolved in 24 hours, for example. This can be done only when the search results are shared in a sharable container.

The search results can be organized by timestamps indicating which results were obtained at what time. Other metadata can also be stored such as source of digital assets searched, search keyword(s), etc.

### Searching Public and Private Repositories of Digital Assets Using a Sharable Container

The technology disclosed can be used to search public and private repositories of digital assets. For example, consider an organization that has a private repository of digital assets that is accessible to authorized users within the organization. A private repository of digital assets can be part of a private digital asset management (DAM) system that is only accessible to authorized users or employees of the organization. Users or participants external to the organization may not have access to private DAM system of the organization. When one of the authorized users who has access to the private DAM system searches for digital assets, that user has access to both public and private (DAM) systems from which digital assets will be searched and returned to the sharable container or the workspace. The authorized user (or internal user of the organization) who has access to private DAM system can invite one or more external users to the collaborative search session. In this case, the external user who does not have access to the private repository or the private DAM system can participate in collaborative search sessions with the authorized user of the organization who has access to the digital assets in the private repository or the private DAM system. The external users (participating in a collaboration session with authorized user) can search digital assets from the private DAM repositories and perform operations on private digital assets such as review, annotation, comments, etc. in the workspace i.e., the sharable container of digital assets. After the collaborative search session ends, the external users may not have access to the search results from the private DAM system. The external user may only access the search results from the private DAM system during the collaborative search session while at least one authorized user is participating in the collaboration session. Therefore, the technology disclosed enables external users and internal (or authorized) users to work collaboratively when searching both external and private sources of digital assets. In one implementation, the internal user or the authorized user can revoke an external user's access to the sharable container or to selected private digital assets in the sharable container or the workspace during the collaborative search session.

The authorized user or internal user of the organization can also define one or more custom filters for sharing the search results with other participants that may not have access to digital assets from private DAM system. For example, a government agency can have up to five or more levels of security (level 1 to level 5) defined for access to their digital assets. Level 1 may represent security level for digital assets with lowest level of security while level 5 may represent highest level of secured digital assets. The authorized user can assign a particular security level to the external user e.g., the registered user can assign level one (or level 1) access to secured digital assets to an external user. When the external user participates in collaborative search, the results will be populated in the workspace (sharable container) using digital assets up to allowed security level such as level 1 in this case. In this case, the digital assets are assigned labels defining their respective security level (e.g., level 1, level 2, etc.). An external user assigned level 5 security approval may be able to view all secured digital assets up to level 5 while an external user assigned security level 2 may only be able to access digital assets assigned level 1 and level 2 security levels.

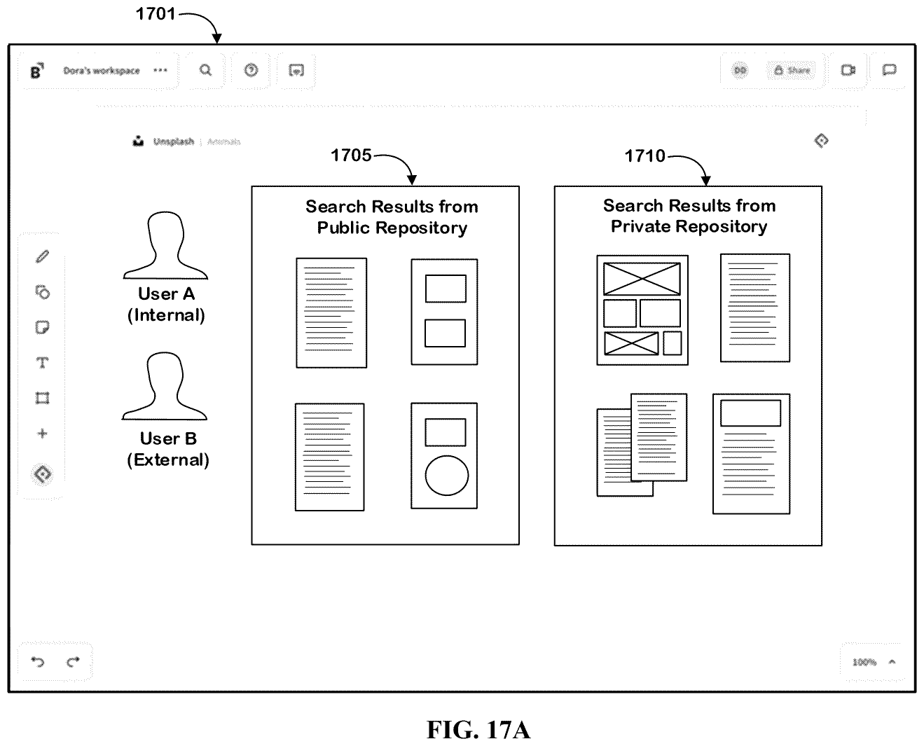

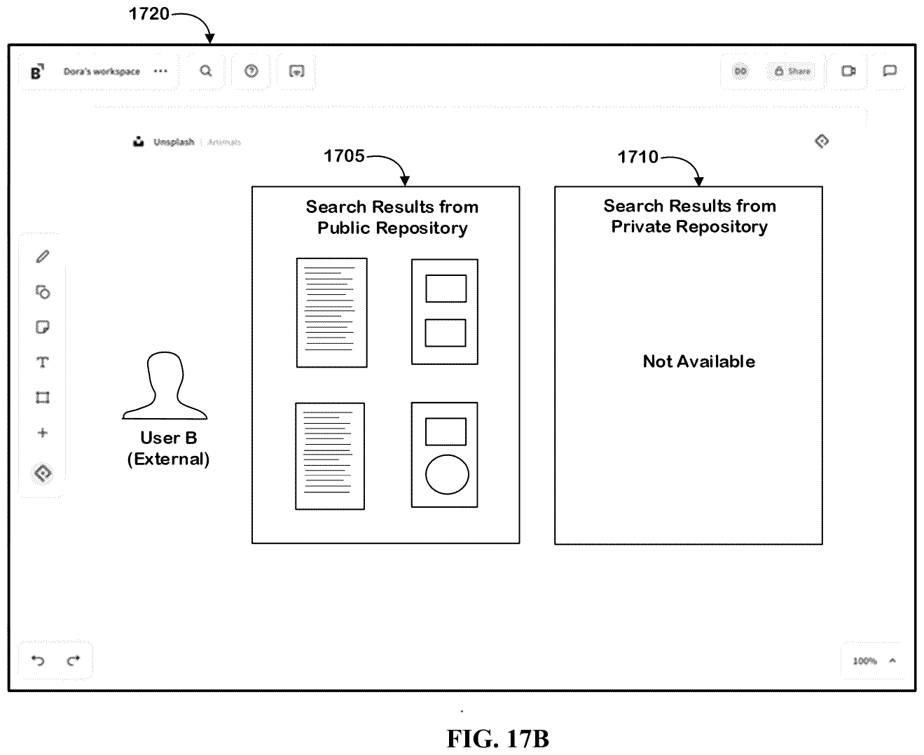

FIG. 17A presents a user interface 1701 illustrating digital assets returned in response to a search performed on public and private repositories of digital assets. The digital assets can be arranged in separate canvases per source or repository of digital assets. For example, the canvas on the left (labeled as 1705) in FIG. 17A shows search results from a public repository of digital assets and search results in a canvas on the right (labeled as 1710) include digital assets matching the search criterion from a private repository of digital assets that is only accessible to authorized users (or internal users) of the organization. There are two users in the collaboration session, user A is an internal user of the organization and user B is external user. The user A has access to the private repository of digital assets, therefore, search results from the private repository are also displayed on the digital display and available to both internal (or authorized) and external users for review.

FIG. 17B shows a user interface 1720 illustrating the digital assets displayed on the canvases 1705 and 1710 when the internal (or authorized) user leaves the collaboration session. In one implementation, when the authorized user is inactive for a pre-defined amount of time such as 5 minutes, 15 minutes, 30 minutes, and so on, the collaboration server determines that the authorized user has left the session. The authorized user can become active again, i.e., by selecting a digital asset or by moving the pointing device. In this case, the collaboration server includes the authorized user in the collaboration session and sends an updated spatial event map to the client node associated with the authorized user. The authorized user can also select a “log out” user interface element or a “exit” user interface element to leave the collaboration session. The authorized user like all other users can join a collaboration session and/or leave the collaboration at any point in time during the collaboration session. The search results from the private repository are taken off from the workspace and not displayed on the digital display associated with client node of external user. This is because external user (or unauthorized user) does not have access to digital assets from the private repository of digital assets. This is illustrated in the updated view of the canvas 1710 in FIG. 17B. A message, “not available” may displayed on the canvas 1710 on a placeholder corresponding to the position of a secured digital asset, indicating to the users that search results from the private repository may not be displayed on the canvas 1710. The message can also include additional information for the user such as indicating to the user that she is not authorized to access and/or view the digital assets from the private repository. The system can include a user interface element or a button that is displayed on the canvas 1710 allowing the external user to send a request to the internal user or an administrator to allow access to external user to view the digital assets. The permission granted to external user can be time restricted, for example for 10 minutes, 1 hour or 12 hours, etc. The external user may only be able to view the digital assets and not make any comments, annotation or edits to digital assets. The administrator may also allow the external user to view selected digital assets from the search results from private repository.

### Particular Implementations

Various implementations of technology disclosed for searching, curating, comparing digital assets, finding similar digital assets and searching of private repositories of digital assets are described herein.

The technology disclosed can be practiced as a system, method, device, product, computer readable media, or article of manufacture. One or more features of an implementation can be combined with the base implementation. Implementations that are not mutually exclusive are taught to be combinable. One or more features of an implementation can be combined with other implementations. This disclosure periodically reminds the user of these options. Omission from some implementations of recitations that repeat these options should not be taken as limiting the combinations taught in the preceding sections—these recitations are hereby incorporated forward by reference into each of the following implementations.

A first method implementation of technology disclosed includes operations for sharing interactive search results among a plurality of users for a collaboration project and/or a collaboration session. The method includes, searching one or more selected sources of digital assets (e.g., Getty Images, Shutterstock, iStock, Giphy, Instagram, Twitter, etc.) in dependence on search keywords via a user interface provided by a collaboration system. The method includes, curating and storing the search results as digital assets in a collaborative workspace. The search results can be stored in containers or canvases within the collaborative workspace. The search results can be curated into separate containers or canvases based on the one or more selected sources. The search results can be identified as digital assets in a spatial event map that is shared between users of the collaborative workspace. The method includes, further curating the search results to store selected digital assets and discard digital assets not required. The method includes, sharing the collaborative search space, including the curated digital assets, with a plurality of users. The method includes, selecting, by one or more users of the plurality of users, one or more digital assets for finding similar digital assets to the one or more selected digital assets. The method includes, further searching one or more selected sources of digital assets (e.g., Getty Images, Shutterstock, iStock, Giphy, Instagram, Twitter, etc.) in dependence on the selected one or more digital assets via a user interface provided by a collaboration system. The method includes, presenting the search results in a group of digital assets in a container of similar digital assets along with the selected one or more digital assets in the collaborative workspace. The method includes, storing the curated and the similar digital assets in the collaborative workspace for next phases of the project.

A second method implementation of technology disclosed includes operations for sharing interactive search results among a plurality of users for a collaboration project and/or a collaboration session. The method includes, searching one or more selected sources of digital assets (e.g., Getty Images, Shutterstock, iStock, Giphy, Instagram, Twitter, etc.) in dependence on search keywords via a webpage (e.g., popsync.io). The method includes, curating and storing the search results on a web server, as digital assets in a collaborative workspace. The search results can be stored in containers or canvases within the collaborative workspace. The search results can be curated into separate containers or canvases based on the one or more selected sources. The search results can be identified as digital assets in a spatial event map that is shared between users of the collaborative workspace. The method includes, further curating the search results to store selected digital assets and discard digital assets not required. The method includes, sharing the webpage to a plurality of users as the collaborative workspace including curated digital assets. The method includes, selecting, by one or more users of the plurality of users, one or more digital assets for finding similar digital assets to the one or more selected digital assets. The method includes, further searching, via the webpage, one or more selected sources of digital assets (e.g., Getty Images, Shutterstock, iStock, Giphy, Instagram, Twitter, etc.) in dependence on the selected one or more digital assets via a user interface provided by a collaboration system. The method includes, presenting the search results in a group of digital assets in a container of similar digital assets along with the selected one or more digital assets in the collaborative workspace. The method includes storing the curated and the similar digital assets in the collaborative workspace for next phases of the project.

A third method implementation of technology disclosed includes operations for sharing interactive search results among a plurality of users for a collaboration project and/or a collaboration session. The method includes, searching one or more selected sources of digital assets (e.g., Getty Images, Shutterstock, iStock, Giphy, Instagram, Twitter, etc.) in dependence on search keywords via a user interface provided by a collaboration system. The method includes curating and storing the search results as digital assets in a collaborative workspace. The search results can be stored in containers or canvases within the collaborative workspace. The search results can be curated into separate containers or canvases based on the one or more selected sources. The search results can be identified as digital assets in a spatial event map that is shared between users of the collaborative workspace. The method includes further curating the search results to store selected digital assets and discard digital assets not required. The method includes sharing the collaborative search space, including the curated digital assets, with a plurality of users. The method includes selecting, by one or more users of the plurality of users, two or more digital assets for comparing the selected digital assets. The method includes, presenting the selected two or more digital assets in a group of digital assets in a container for comparing the selected digital assets in the collaborative workspace. The method includes storing the curated and the selected two or more digital assets in the collaborative workspace for next phases of the project.

A fourth method implementation of technology disclosed includes operations for sharing interactive search results among a plurality of users for a collaboration project and/or a collaboration session. The method includes searching one or more selected sources of digital assets (e.g., Getty Images, Shutterstock, iStock, Giphy, Instagram, Twitter, etc.) in dependence on search keywords via a webpage (e.g., popsync.io). The method includes curating and storing the search results on a web server, as digital assets in a collaborative workspace. The search results can be stored in containers or canvases within the collaborative workspace. The search results can be curated into separate containers or canvases based on the one or more selected sources. The search results can be identified as digital assets in a spatial event map that is shared between users of the collaborative workspace. The method includes, further curating the search results to store selected digital assets and discard digital assets not required. The method includes, sharing the webpage to a plurality of users as the collaborative workspace including curated digital assets. The method includes selecting, by one or more users of the plurality of users, two or more digital assets for comparing the selected digital assets. The method includes, presenting, via the webpage, the selected two or more digital assets in a group of digital assets in a container for comparing the selected digital assets in the collaborative workspace. The method includes, storing the curated and the selected two or more digital assets in the collaborative workspace for next phases of the project.

A fifth method implementation of technology disclosed includes operations for sharing interactive search results among a plurality of users for a collaboration project and/or a collaboration session. The method includes, searching, in a first time interval, one or more selected sources of digital assets (e.g., Getty Images, Shutterstock, iStock, Giphy, Instagram, Twitter, etc.) in dependence on search keywords via a user interface provided by a collaboration system to obtain first search results. The method includes, curating and storing the first search results as digital assets in a collaborative workspace. The first search results can be stored in containers or canvases within the collaborative workspace. The first search results can be curated into separate containers or canvases based on the one or more selected sources. The first search results can be identified as digital assets in a spatial event map that is shared between users of the collaborative workspace. The method includes, sharing the collaborative search space, including the curated digital assets in the first search results, with a plurality of users. The method includes, searching, in a second time interval, one or more selected sources of digital assets (e.g., Getty Images, Shutterstock, iStock, Giphy, Instagram, Twitter, etc.) in dependence on the search keywords via the user interface provided by a collaboration system to obtain second search results. The method includes, curating and storing the second search results as digital assets in a collaborative workspace. The second search results can be stored in containers or canvases within the collaborative workspace. The second search results being curated into separate containers or canvases based on the one or more selected sources. The second search results being identified as digital assets in a spatial event map that is shared between users of the collaborative workspace. The method includes, storing the first and second search results with their respective time interval data in the collaborative workspace for next phases of the project and visually comparing the first and second search results.

A sixth method implementation of technology disclosed includes operations for sharing interactive search results among a plurality of users for a collaboration project and/or in a collaboration session. The method includes, searching, in a first time interval, one or more selected sources of digital assets (e.g., Getty Images, Shutterstock, iStock, Giphy, Instagram, Twitter, etc.) in dependence on search keywords via a webpage (e.g., popsync.io) to obtain first search results. The method includes curating and storing the first search results as digital assets in a collaborative workspace. The first search results can be stored in containers or canvases within the collaborative workspace. The first search results can be curated into separate containers or canvases based on the one or more selected sources. The first search results can be identified as digital assets in a spatial event map that is shared between users of the collaborative workspace. The method includes, sharing the webpage, including the curated digital assets in the first search results, with a plurality of users. The method includes, searching, in a second time interval, one or more selected sources of digital assets (e.g., Getty Images, Shutterstock, iStock, Giphy, Instagram, Twitter, etc.) in dependence on the search keywords via the webpage to obtain second search results. The method includes, curating and storing the second search results as digital assets in a collaborative workspace. The second search results can be stored in containers or canvases within the collaborative workspace and the second search results can be curated into separate containers or canvases based on the one or more selected sources. The second search results can be identified as digital assets in a spatial event map that is shared between users of the collaborative workspace. The method includes, storing the first and second search results with their respective time interval data in the collaborative workspace for next phases of the project and visually comparing the first and second search results.

A seventh method implementation of technology disclosed includes operations for sharing interactive search results among a plurality of users for a collaboration project and/or a collaboration session. The method includes, searching by at least one internal user of an organization, one or more selected sources of digital assets (e.g., Getty Images, Shutterstock, iStock, Giphy, Instagram, Twitter, etc.) in dependence on search keywords via a user interface provided by a collaboration system wherein the one or more selected sources of digital assets include at least one private source of digital assets not accessible to external users and only accessible to the at least one internal user of the organization and at least one public source of digital assets accessible to all users, to obtain first results including digital assets from the at least one private source of digital assets and the at least one public source of digital assets. The method includes, curating and storing the first search results as digital assets in a collaborative workspace. The search results can be stored in containers or canvases within the collaborative workspace. The search results can be curated into separate containers or canvases based on the one or more selected sources. The search results can be identified as digital assets in a spatial event map that is shared between users of the collaborative workspace. The method includes, sharing the collaborative search space, including the curated digital assets in the first search results, with a plurality of users including at least one external user. The method includes, removing the digital assets from the curated digital assets sourced from the private source of digital assets when the at least one internal user of the organization leaves the collaboration session. The method includes, storing the curated digital assets in the collaborative workspace for next phases of the project.

An eighth method implementation of technology disclosed includes operations for sharing interactive search results among a plurality of users for a collaboration project or in a collaboration session. The method includes, searching by at least one internal user of an organization, one or more selected sources of digital assets (e.g., Getty Images, Shutterstock, iStock, Giphy, Instagram, Twitter, etc.) in dependence on search keywords via a webpage wherein the one or more selected sources of digital assets include at least one private source of digital assets not accessible to external users and only accessible to the at least one internal user of the organization and at least one public source of digital assets accessible to all users, to obtain first results including digital assets from the at least one private source of digital assets and the at least one public source of digital assets. The method includes, curating and storing the first search results as digital assets in a collaborative workspace. The search results can be stored in containers or canvases within the collaborative workspace. The search results can be curated into separate containers or canvases based on the one or more selected sources. The search results can be identified as digital assets in a spatial event map that is shared between users of the collaborative workspace. The method includes, sharing the webpage, including the curated digital assets in the first search results, with a plurality of users including at least one external user. The method includes, removing the digital assets from the curated digital assets sourced from the private source of digital assets when the at least one internal user of the organization leaves the collaboration session. The method includes, storing the curated digital assets in the collaborative workspace for next phases of the project.

A system implementation of the technology disclosed includes one or more processors coupled to memory. The memory is loaded with computer instructions to perform the methods one to eight described above. Each of the features discussed in this particular implementation section for the eight method implementations apply equally to the system implementation.

A computer readable media (CRM) implementation includes a non-transitory computer readable storage medium storing instructions executable by a processor to perform methods one through eight as described above. Another CRM implementation may include a system including memory and one or more processors operable to execute instructions, stored in the memory, to perform methods one through eight as described above.

Any data structures and code described or referenced above are stored according to many implementations on a computer-readable storage medium, which may be any device or medium that can store code and/or data for use by a computer system. This includes, but is not limited to, volatile memory, non-volatile memory, application-specific integrated circuits (ASICs), field-programmable gate arrays (FPGAs), magnetic and optical storage devices such as disk drives, magnetic tape, CDs (compact discs), DVDs (digital versatile discs or digital video discs), or other media capable of storing computer-readable media now known or later developed.

### Computer System

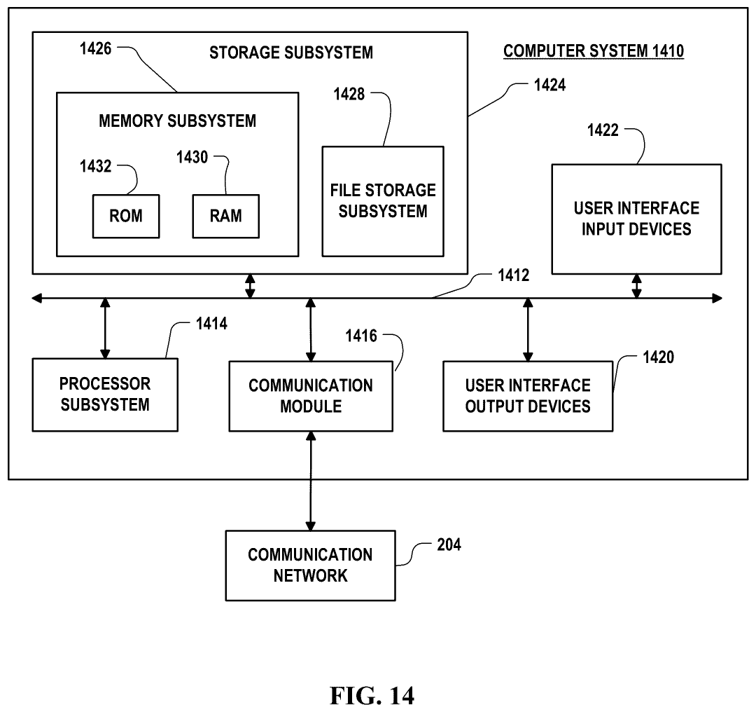

FIG. 14 is a simplified block diagram of a computer system, or network node, which can be used to implement the client functions (e.g., computer system 210) or the server-side functions (e.g., server 205) for processing curating data in a distributed collaboration system. A computer system typically includes a processor subsystem 1414 which communicates with a number of peripheral devices via bus subsystem 1412. These peripheral devices may include a storage subsystem 1424, comprising a memory subsystem 1426 and a file storage subsystem 1428, user interface input devices 1422, user interface output devices 1420, and a communication module 1416. The input and output devices allow user interaction with the computer system. Communication module 1416 provides physical and communication protocol support for interfaces to outside networks, including an interface to communication network 204, and is coupled via communication network 204 to corresponding communication modules in other computer systems. Communication network 204 may comprise many interconnected computer systems and communication links. These communication links may be wireline links, optical links, wireless links, or any other mechanisms for communication of information, but typically it is an IP-based communication network, at least at its extremities. While in one embodiment, communication network 204 is the Internet, in other embodiments, communication network 204 may be any suitable computer network.

The physical hardware component of network interfaces is sometimes referred to as network interface cards (NICs), although they need not be in the form of cards: for instance, they could be in the form of integrated circuits (ICs) and connectors fitted directly onto a motherboard, or in the form of macrocells fabricated on a single integrated circuit chip with other components of the computer system.

User interface input devices 1422 may include a keyboard, pointing devices such as a mouse, trackball, touchpad, or graphics tablet, a scanner, a touch screen incorporated into the display (including the touch sensitive portions of large format digital display such as 102c), audio input devices such as voice recognition systems, microphones, and other types of tangible input devices. In general, use of the term “input device” is intended to include all possible types of devices and ways to input information into the computer system or onto communication network 204.

User interface output devices 1420 may include a display subsystem, a printer, a fax machine, or non-visual displays such as audio output devices. The display subsystem may include a cathode ray tube (CRT), a flat panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from the computer system to the user or to another machine or computer system.

Storage subsystem 1424 stores the basic programming and data constructs that provide the functionality of certain embodiments of the present invention.

The storage subsystem 1424 when used for implementation of server nodes, comprises a product including a non-transitory computer readable medium storing a machine-readable data structure including a spatial event map which locates events in a workspace, wherein the spatial event map includes a log of events, entries in the log having a location of a graphical target of the event in the workspace and a time. Also, the storage subsystem 1424 comprises a product including executable instructions for performing the procedures described herein associated with the server node.

The storage subsystem 1424 when used for implementation of client-nodes, comprises a product including a non-transitory computer readable medium storing a machine readable data structure including a spatial event map in the form of a cached copy as explained below, which locates events in a workspace, wherein the spatial event map includes a log of events, entries in the log having a location of a graphical target of the event in the workspace and a time. Also, the storage subsystem 1424 comprises a product including executable instructions for performing the procedures described herein associated with the client node.

For example, the various modules implementing the functionality of certain embodiments of the invention may be stored in storage subsystem 1424. These software modules are generally executed by processor subsystem 1414.

Memory subsystem 1426 typically includes a number of memories including a main random-access memory (RAM) 1430 for storage of instructions and data during program execution and a read only memory (ROM) 1432 in which fixed instructions are stored. File storage subsystem 1428 provides persistent storage for program and data files, and may include a hard disk drive, a floppy disk drive along with associated removable media, a CD ROM drive, an optical drive, or removable media cartridges. The databases and modules implementing the functionality of certain embodiments of the invention may have been provided on a computer readable medium such as one or more CD-ROMs and may be stored by file storage subsystem 1428. The host memory 1426 contains, among other things, computer instructions which, when executed by the processor subsystem 1414, cause the computer system to operate or perform functions as described herein. As used herein, processes and software that are said to run in or on the “host” or the “computer,” execute on the processor subsystem 1414 in response to computer instructions and data in the host memory subsystem 1426 including any other local or remote storage for such instructions and data.

Bus subsystem 1412 provides a mechanism for letting the various components and subsystems of a computer system communicate with each other as intended. Although bus subsystem 1412 is shown schematically as a single bus, alternative embodiments of the bus subsystem may use multiple busses.

The computer system 1410 itself can be of varying types including a personal computer, a portable computer, a workstation, a computer terminal, a network computer, a television, a mainframe, a server farm, or any other data processing system or user device. In one embodiment, a computer system includes several computer systems, each controlling one of the tiles that make up the large format display such as 102c. Due to the ever-changing nature of computers and networks, the description of computer system 210 depicted in FIG. 14 is intended only as a specific example for purposes of illustrating the preferred embodiments of the present invention. Many other configurations of the computer system are possible having more or less components than the computer system depicted in FIG. 14. The same components and variations can also make up each of the other devices 102 in the collaboration environment of FIG. 1, as well as the collaboration server 205 and database 206 as shown in FIG. 2.

Certain information about the drawing regions active on the digital display 102c are stored in a database accessible to the computer system 210 of the display client. The database can take on many forms in different embodiments, including but not limited to a MongoDB database, an XML database, a relational database, or an object-oriented database.

The applicant hereby discloses in isolation each individual feature described herein and any combination of two or more such features, to the extent that such features or combinations are capable of being carried out based on the present specification as a whole in light of the common general knowledge of a person skilled in the art, irrespective of whether such features or combinations of features solve any problems disclosed herein, and without limitation to the scope of the claims. The applicant indicates that aspects of the present technology may consist of any such feature or combination of features. In view of the foregoing description, it will be evident to a person skilled in the art that various modifications may be made within the scope of the technology.

The foregoing description of preferred embodiments of the present technology has been provided for the purposes of illustration and description. It is not intended to be exhaustive or to limit the technology to the precise forms disclosed. Obviously, many modifications and variations will be apparent to practitioners skilled in this art. For example, though the displays described herein are of large format, small format displays can also be arranged to use multiple drawing regions, though multiple drawing regions are more useful for displays that are at least as large as 12 feet in width. In particular, and without limitation, any and all variations described, suggested by the Background section of this patent application or by the material incorporated by reference are specifically incorporated by reference into the description herein of embodiments of the technology. In addition, any and all variations described, suggested or incorporated by reference herein with respect to any one embodiment are also to be considered taught with respect to all other embodiments. The embodiments described herein were chosen and described in order to best explain the principles of the technology and its practical application, thereby enabling others skilled in the art to understand the technology for various embodiments and with various modifications as are suited to the particular use contemplated. It is intended that the scope of the technology be defined by the following claims and their equivalents.

What is claimed is:

1. A method for operating a server node, the method comprising:
searching, by the server node, one or more sources of digital assets in dependence on one or more keywords received from a first client node participating in a collaboration session;
identifying initial results from the searching of the one or more sources of digital assets, the initial results being accessible by any client node participating in the collaboration session;
receiving, at the server node and from at least one client node, an identification of a particular digital asset from the initial results;
further searching, by the server node, the one or more sources of digital assets in dependence on the identified particular digital asset to obtain further results; and
curating, by the server node, the further results as digital assets in a workspace that is accessible in the collaboration session, the digital assets being curated into separate canvases within the workspace in dependence on at least one criterion.

2. The method of claim 1, wherein the identification of the particular digital asset includes at least one keyword.

3. The method of claim 2, wherein the one or more sources of digital assets include one or more publicly available sources of images.

4. The method of claim 3, wherein the one or more publicly available sources of images include at least one of Getty Images, Shutterstock, iStock, Giphy, Instagram, and Twitter.

5. The method of claim 1, wherein the identification of the particular digital asset includes data that includes at least a portion of the digital asset.

6. The method of claim 5, wherein the particular digital asset is at least one of an image, a video clip, an audio clip and a three-dimensional model.

7. The method of claim 1, further including:
inputting at least a portion of the particular digital asset to a trained machine learning model; and
receiving at least one classification for the particular digital asset from the trained machine learning model,
wherein the further searching includes searching, by the server node, the one or more sources of digital assets in dependence on the classification of the particular digital asset.

8. The method of claim 1, further including:
receiving, at the server node and from at least one client node, an identification of at least two digital assets selected for comparison from the initial results; and
curating, by the server node, the at least two digital assets selected for comparison in a workspace, the at least two digital assets selected for comparison placed side-by-side in a same canvas.

9. The method of claim 1,
wherein the initial results are accessible to the client nodes participating in the collaboration session as a result of the server node providing, to the client nodes, a spatial event map identifying a log of events in the workspace,
wherein entries within the log of events include respective locations of digital assets related to (i) events in the workspace and (ii) times of the events, and
wherein a particular event identified by the spatial event map is related to the curating of the further results.

10. The method of claim 1, wherein the one or more sources of digital assets includes at least one private repository of digital assets that is only accessible to authorized users.

11. The method of claim 10,
wherein, the further searching includes searching, by the server node, the at least one private repository of digital assets,
wherein the client nodes include an authorized client node operated by an authorized user to access the at least one private repository of digital assets, and
wherein the curated further results include at least one private digital asset from the least one private repository of digital assets.

12. The method of claim 11,
receiving, at the server node, an event from the authorized client node identifying that the authorized user has left the collaboration session; and
sending, from the server node, an update event to client nodes that allows display of an updated workspace at respective client nodes, wherein, for a client node that is not an authorized client node, the updated workspace prevents display of the at least one private digital asset from the least one private repository of digital assets.

13. The method of claim 1, further including:
receiving, at the server node, from at least one client node, identification of at least two digital assets from the initial results;
generating common features of the at least two digital assets by providing at least a portion of each of the at least two digital assets to a trained machine learning mode; and
further searching, by the server node, the one or more sources of digital assets in dependence on the generated common features of the at least two digital assets.

14. The method of claim 1, further including:
receiving, at the server node, from at least one client node, identification of at least two digital assets from the initial results; and
further searching, by the server node, the one or more sources of digital assets in dependence on the identified at least two digital assets form the initial results.

15. A system including one or more processors coupled to memory, the memory loaded with computer instructions to send data identifying digital assets in a workspace, the instructions, when executed on the processors, implement, at a server node, actions comprising:
searching, by the server node, one or more sources of digital assets in dependence on one or more keywords received from a first client node participating in a collaboration session;
identifying initial results from the searching of the one or more sources of digital assets, the initial results being accessible by any client node participating in the collaboration session;
receiving, at the server node and from at least one client node, an identification of a particular digital asset from the initial results;
further searching, by the server node, the one or more sources of digital assets in dependence on the identified particular digital asset to obtain further results; and
curating, by the server node, the further results as digital assets in a workspace that is accessible in the collaboration session, the digital assets being curated into separate canvases within the workspace in dependence on at least one criterion.

16. The system of claim 15, further implanting actions comprising:
inputting at least a portion of the particular digital asset to a trained machine learning model; and
receiving at least one classification for the particular digital asset from the trained machine learning model,
wherein the further searching includes searching, by the server node, the one or more sources of digital assets in dependence on the classification of the particular digital asset.

17. The system of claim 15, further implementing actions comprising:
receiving, at the server node and from at least one client node, an identification of at least two digital assets selected for comparison from the initial results; and
curating, by the server node, the at least two digital assets selected for comparison in a workspace, the at least two digital assets selected for comparison placed side-by-side in a same canvas.

18. The system of claim 15,
wherein the initial results are accessible to the client nodes participating in the collaboration session as a result of the server node providing, to the client nodes, a spatial event map identifying a log of events in the workspace,
wherein entries within the log of events include respective locations of digital assets related to (i) events in the workspace and (ii) times of the events, and
wherein a particular event identified by the spatial event map is related to the curating of the further results.

19. A non-transitory computer readable storage medium impressed with computer program instructions to send data identifying digital assets in a workspace, the instructions, when executed on a processor, implement a method, of a server node, comprising:
searching, by the server node, one or more sources of digital assets in dependence on one or more keywords received from a first client node participating in a collaboration session;
identifying initial results from the searching of the one or more sources of digital assets, the initial results being accessible by any client node participating in the collaboration session;
receiving, at the server node and from at least one client node, an identification of a particular digital asset from the initial results;
further searching, by the server node, the one or more sources of digital assets in dependence on the identified particular digital asset to obtain further results; and
curating, by the server node, the further results as digital assets in a workspace that is accessible in the collaboration session, the digital assets being curated into separate canvases within the workspace in dependence on at least one criterion.

20. The non-transitory computer readable storage medium of claim 19, wherein the identification of the particular digital asset includes at least one keyword.
